(19) United States
(12) Patent Application Publication
(10) Pub. No.: US 2024/0185145 A1
(43) Pub. Date: Jun. 6, 2024

(54) Restaurant Management System including Patron Table Management System, and Methods of Operating Same

(71) Applicant: Samuel P. Steinberg, Austin, TX (US)

(72) Inventor: Samuel P. Steinberg, Austin, TX (US)

(21) Appl. No.: 18/171,335

(22) Filed: Feb. 18, 2023

Related U.S. Application Data
(60) Provisional application No. 63/385,672, filed on Dec. 1, 2022.

(51) Int. Cl. G06Q 10/063; G06Q 50/12; H04W 4/80

(52) U.S. Cl. CPC G06Q 10/063; G06Q 50/12; H04W 4/80

(57) ABSTRACT

A patron table management system for a restaurant including a plurality of patron tables comprising: a plurality of tag indicators, each tag indicator includes an NFC tag (unique identification data which is stored therein) that is secured to and associated with a particular patron table. The system also includes a mobile handheld device including: a tag reader to read the unique identification data stored in a NFC tag of a tag indicator when in operable proximity thereto, and wireless communication circuitry configured to transmit (i) unique identification data stored in the NFC tag and (ii) a status of the patron table associated therewith, wherein the status of a table includes a table clean or table ready. A central station is configured to receive the wireless transmission and output information of a status of each patron table of the plurality of patron tables of the restaurant (e.g., via a display).

The present inventions are directed to restaurant management systems including a patron table management system to input, generate, transmit/output (i) a status and/or a state of one or more, or all of the patron tables of the restaurant, and/or (ii) a change or an update of a status and/or a state of one or more, or all of the patron tables of the restaurant. For example, the status and/or a state of a patron table of the restaurant may be one or more (or all) of the following: table occupied or patron(s) seated (i.e., patron(s) occupy the table), clean/ready (i.e., the patron table is clean and/or ready to be occupied by patron(s)), table dirty (the table is dirty, for example, from the immediately previous patron(s)), and/or cleaning in process (i.e., an attendant is in the process of cleaning the table to prepare the table to be occupied by patron(s)). Notably, these aforementioned states/statuses of the patron table (i.e., those tables of a restaurant that patrons are seated and served and subsequently serviced by the restaurant staff) are merely exemplary wherein other/different/additional table states may be employed and/or the focus of the management system.

The patron table management system, in one embodiment, includes a plurality of tag indicators, each tag indicator (e.g., an NFC tag, an RFID tag, a QR code, a barcode, etc.) includes identification data, which is stored or programmed in the tag indicator, that uniquely identifies each tag indicator. The identification data of the tag indicator may be wirelessly detected and/or read via, for example, optically, inductively and/or electronically. When deployed, the tag indicator is secured or fixed to a particular patron table of the restaurant (e.g., the tag indicator is secured to the underside of the patron table). In this way, each tag indicator is associated with a unique patron table wherein the tag indicator uniquely identifies the associated patron table (to which the tag indicator is secured or affixed) via the identification data which is stored or programmed in the tag indicator.

The patron table management system also includes one or more mobile handheld devices, having tag indicator detector/reader, and associated electronics, to detect and/or read the unique identifier of the tag indicator (e.g., read the NFC tag and/or detect the RFID signal emitted by the RFID tag) that is affixed to the patron table. In one embodiment, the tag indicator detector/reader may via optically, inductively and/or electronically detect and/or read the identification data of the tag indicator. In one embodiment, each handheld device includes a wireless transmitter to output, transmit and/or provide (via an Intranet and/or Internet) data which is representative of a status and/or a state of the patron table (and/or a change or an update of a status and/or a state of the patron table) associated with the unique identifier of the tag indicator (secured or affixed to that patron table) that is detected or read by the handheld device. In one embodiment, the handheld device outputs, transmits and/or provides (i) data which is representative of the state/status and/or change in state/status of a particular patron table and (ii) data which is representative of the table corresponding thereto, via the wireless transmitter, to a central station (e.g., computer and/or display/terminal at a host or hostess station or desk) of the restaurant management system. In that way, a mobile handheld device may output or transmit the state/status, and/or change in state/status, of a particular patron table of the restaurant (from a plurality of patron tables), via reading or detecting the unique identifier of the tag indicator (which, in one embodiment, is stored or programmed in the tag indicator) wherein the information of the state/status and/or change in state/status of one or more (or all) of the patron tables are received (e.g., via a Wi-Fi) by the central station and, in one embodiment, presented to and/or organized for a host/hostess to manage the flow and/or experience of patrons.

Notably, in one embodiment, the mobile handheld device is operated by a table attendant (e.g., an individual and/or restaurant employee who is responsible for cleaning, bussing and/or setting/re-setting the patron table), for example, during maintaining/managing the patron table or state of the patron table. The handheld device may include a display, a user interface (e.g., touch-screen type, speaker, and/or keypad), a processor, a detector/reader that is configurable to via optically, inductively and/or electronically detect and/or read (wirelessly) the identification data (unique identification data) of the tag indicator that uniquely identifies the patron table associated therewith, communication circuitry (e.g., wireless transmitter, for example, Wi-Fi) to output, transmit and/or provide the state/status and/or change in state/status of a patron table to a central station (e.g., a host/hostess station or desk) of the restaurant management system. The handheld device(s) and the central station of the restaurant management system may communicate via the Internet and/or via an Intranet (a local and/or restricted communications network interconnecting (e.g., wirelessly) the components of the restaurant management system into, for example, a private network). Indeed, in one embodiment, as discussed in more detail below, the handheld device(s) and/or the central station of the restaurant management system may communicate, via the Internet, to a remote processing system (e.g., one or more servers in the “cloud”) to, for example, generate data analytics using, based on and/or related to data of the (i) status and/or a state of one or more, or all of the patron tables of the restaurant, and/or (ii) change of status and/or state of one or more, or all of the patron tables of the restaurant.

The table attendant accesses the unique identifier of the tag indicator of an associated table via the detector/reader of the handheld device (e.g., via positioning the detector/reader of the handheld device in operable proximity (optically, inductively and/or electronically) of the NFC tag, RFID tag, a QR code and/or bar code of, on and/or in the tag indicator). In response, in one embodiment, the handheld device may display the possible states/statuses of the patron table (e.g., a plurality (or all) of those states/statuses discussed above) and await/request the table attendant to select or enter a “new” state/status or update a state/status of the patron table. For example, in one embodiment, the handheld device may display a pull-down menu wherein the table attendant may select/input the appropriate state/status according to the state/status of the patron table associated with the tag indicator (e.g., “clean/ready” (i.e., the patron table is clean and ready to be occupied by patron(s)) after the table attendant has serviced (cleaned and set) the patron table). For ease of operation and to facilitate uniformity of selection/input of the state/status of a patron table, the pull-down menu may present the table attendant with a limited number of options to select/input/confirm.

In one embodiment, the current state/status of the patron table may be stored in memory in the handheld device and, in response to accessing the unique identifier of the tag indicator of an associated table via the detector/reader of the handheld device, the handheld device may display the previously known state/status of the patron table and await/request the table attendant to confirm the anticipated next or new current state/status of the patron table (e.g., via a confirmation input “button” on a display (e.g., touch-screen type) and/or a keypad). In this embodiment, the anticipated next state/status of the patron table (and anticipated change in state/status thereof) is based on the previous state/status of the patron table. For example, where the previous state/status of the patron table was table occupied or patron(s) seated (i.e., patron(s) occupy the table), when the table attendant accesses the unique identifier of the tag indicator of an associated table via the handheld device, the next state/status of the patron table may be table dirty (the table is dirty, for example, from the immediately previous patron(s)) and/or cleaning in process (i.e., an attendant is in the process of cleaning the table to prepare the table to be occupied by patron(s)). After the table attendant has serviced (cleaned and set) the patron table and the table attendant may again access the tag indicator of an associated table via handheld device wherein the state/status of the patron table may be automatically, or in response to confirmation input (from the table attendant), updated to the state/status of the patron table to clean and ready to be occupied by patron(s) (i.e., after the table attendant has serviced (cleaned and set) the patron table).

Notably, in one embodiment, the system may not include all of the states/statuses as indicated above. For example, in one embodiment, the system may not include a state/status of the patron table being dirty (the table is dirty, for example, from the immediately previous patron(s)) and, when the table attendant accesses the tag indicator of an associated table via the detector/reader of the handheld device (e.g., after servicing and setting the patron table), the state/status of the patron table may be immediately updated to patron table is clean and ready to be occupied by patron(s)) after the table attendant has serviced (cleaned and set) the patron table. In this embodiment, the table attendant may access the tag indicator of an associated table via the detector/reader of the handheld device only after servicing and setting the patron table when the previous patrons have departed the table.

In another embodiment, in lieu of storing or maintaining the current state/status of the patron table(s) in the handheld device, or in addition thereto, upon accessing the tag indicator of an associated table via the detector/reader of the handheld device, the handheld device may receive, retrieve, request and/or download the state/status of the patron table (based on the unique identifier of the tag indicator affixed to the associated table as detected/read by the detector/reader of the handheld device) from, for example, the central station (via communication circuitry (e.g., wireless transmitter/receiver in/of the handheld device)), as stored or maintained in memory therein. Thereafter, a change in the state/status may be implemented using any of the techniques or processes described herein. For example, after the table attendant has serviced the patron table (cleaned and set), the table attendant may again access the tag indicator of an associated table via the detector/reader of the handheld device wherein the state/status of the patron table may be automatically, or in response to confirmation input (from the table attendant on, for example, a touch screen), updated to a clean and ready to be occupied by patron(s)) state/status which may be output or transmitted to the central station (via a wireless transmitter of the handheld device).

Alternatively, in lieu of storing or maintaining the current state/status of the patron table(s) in the handheld device, or in addition thereto, upon accessing the tag indicator of an associated patron table via the detector/reader of the handheld device, the handheld device communicates to the central station (via communication circuitry (e.g., wireless transmitter in/of the handheld device)), the patron table associated with the tag indicator. In response, the central station changes the state/status of that patron table to an anticipated next state/status of the patron table based on the previous state/status of the patron table—which is known to, maintained and/or stored in the central station. For example, where a patron table is dirty, a table attendant, before accessing the tag indicator for that particular table, may service the patron table (cleaned and set). Thereafter, the table attendant may access the tag indicator of an associated table via the handheld device. In response, the handheld device transmits the information identifying the particular patron table and the central station, in response to such information, changes, updates and/or sets (e.g., automatically) the state/status of the associated patron table to a clean and ready to be occupied by patron(s)) state/status.

In one embodiment, the handheld device includes a user interface having a physical, audio and/or visual feedback device. The handheld device of this embodiment, may or may not include a display and/or a user interface (e.g., touch-screen type and keypad). The handheld device of this embodiment, however, includes a detector/reader that is configurable to optically, inductively and/or electronically detect and/or read (wirelessly) the identification data of the tag indicator that uniquely identifies the patron table associated therewith, and communication circuitry (e.g., wireless transmitter, for example, Wi-Fi) to output, transmit and/or provide the state/status and/or change in state/status of a patron table. In one embodiment, the user interface includes one or more physical (e.g., haptic vibration device), audio (e.g., speaker/buzzer) and/or visual (e.g., illumination such as LED(s)) feedback device(s) but does not include a display and keypad/button(s). For example, in one embodiment, the user interface includes a physical device (e.g., haptic vibration device) but does not include a display and keypad/button(s). A handheld device of this embodiment may be suitable for limited interaction between the table attendant (via the handheld device) and the central station wherein the table attendant need not specifically select/input a patron table state/status (and/or change therein) via, for example, a display (e.g., touch-screen type) and/or keypad. Rather, as discussed immediately above, upon accessing the tag indicator of an associated patron table via the detector/reader of the handheld device, the handheld device communicates to the central station (via, e.g., wireless transmitter in/of the handheld device)), the patron table associated with the tag indicator. In response, the central station changes the state/status of that patron table to an anticipated next state/status of the patron table based on the previous state/status of the patron table—which is known to, maintained and/or stored in the central station. The physical (e.g., haptic vibration device), audio (e.g., speaker/buzzer) and/or visual (e.g., illumination such as LED(s)) feedback device(s) may provide feedback to the table attendant that the restaurant management system (e.g., the central station) acknowledges and/or has registered the updated state/status via accessing the tag indicator.

Thus, in this embodiment, by accessing the tag indicator, the table attendant may update the state/status and/or change in state/status of a patron table when the detector/reader (optically, inductively and/or electronically) detects and/or reads the identification data of the tag indicator that uniquely identifies the patron table associated therewith, and communication circuitry outputs and transmits a signal to the central station that the handheld device has accessed the tag indicator. The central station (e.g., a host/hostess station or desk) of the restaurant management system updates or changes the state/status of a patron table relative to the previous state/status (e.g., if the previous state/status was table occupied by patron(s), the updated state/status (in response to accessing the tag indicator) may be “clean/ready” (i.e., the patron table is clean and ready to be occupied by patron(s)).

In an alternative embodiment, the handheld device(s) of the restaurant management system may transmit, output and/or provide, via the Internet or other communication network, data corresponding to the state/status and/or change in state/status of one or more, or all of the patron table(s) of a given restaurant directly to one or more remote processing systems (e.g., one or more servers in the “cloud”). Thus, in this embodiment, the handheld device(s) communicate directly to remote processing system(s) to provide data (for example, in real-time) of the state/status and/or change in state/status of one or more, or all of the patron table(s). The remote processing system(s) may thereafter communicate directly with the central station to provide data (for example, in real-time) of the state/status and/or change in state/status of one or more, or all of the patron table(s). The remote processing system (e.g., one or more servers in the “cloud”) may, in addition, generate data analytics using, based on and/or related to data of the (i) status and/or a state of one or more, or all of the patron tables of the restaurant, and/or (ii) change of status and/or state of one or more, or all of the patron tables of the restaurant. The remote processing system may provide the data analytics to the central station wherein the restaurant (e.g., management) may analyze such data to improve customer/patron experience and management of the restaurant.

Notably, in one embodiment, the updated state/status may employ preprogrammed and/or fixed sequence (based on the previous state) and there is no selection, input or confirmation by the table attendant. For example, in one embodiment, a predefined sequence of the patron table state/status may include (i) patron table clean/ready (i.e., the patron table is clean and ready to be occupied by patron(s)), (ii) patron table occupied or patron(s) seated (i.e., patron(s) occupy the table), and (iii) patron table dirty (the table is dirty, for example, from the immediately previous patron(s)). The order of the predefined sequence may be fixed such that where the state/status of a given table is “patron table dirty”, the next state/status of that table is “patron table clean/ready”. In another embodiment, the predefined sequence of the table includes a state/status of “cleaning in process” (i.e., an attendant is in the process of cleaning the table to prepare the table to be occupied by patron(s)). In this embodiment, a predefined sequence of the patron table state/status may be (i) patron table clean/ready, (ii) patron table occupied or patron(s) seated, (iii) patron table dirty, and/or (iv) cleaning in process.

As intimated above, the aforementioned patron table states are merely exemplary wherein other/different/additional table states may be employed. Any table state now known or later developed may be employed and all such states (e.g., those that are advantageous to track via the system) are intended to fall within the scope of the present inventions. Indeed, in yet another embodiment, the predefined sequence of the states/statuses of the patron table may include two states including, for example, (i) patron table clean/ready and (ii) patron table dirty; or (i) patron table clean/ready and (ii) patron table occupied or patron(s) seated. Moreover, where the system employs one or more predefined sequences of states, the aforementioned patron table states are merely exemplary—any order sequence(s) now known or later developed are intended to fall within the scope of the present inventions.

As noted above, the central station of the restaurant management system may receive data representative of the state/status of one or more (or all) of the patron table in the restaurant (e.g., via a Wi-Fi) wherein the central station may “manage” the restaurant accordingly. That is, each handheld device, via the table attendant positioning or placing the handheld device in operable proximity to the tag indicator (e.g., an NFC tag, an RFID tag, a barcode, etc.) on and/or affixed to each patron table (e.g., secured to the underside of the patron table), may output, transmit and/or provide a state/status and/or change in state/status of the associated patron table to a central station (e.g., a host/hostess station or desk) of the restaurant management system. In response, the central station of the restaurant management system may generate and/or output (in text or graphical form) the status or state (and/or changes therein) of each patron table, based on information output or provided to the central station via the handheld device(s), for review or consideration of the operator of the central station (e.g., the host/hostess). In one embodiment, a display of the central station depicts the status or state (and/or changes therein) of each patron table graphically, for example, in “map” or floor layout form (e.g., a floor plan including, for example, a color coded symbol for each patron table wherein each symbol (e.g., a table) is located relative to each in a layout representative of the location of each patron table on the restaurant floor, and a color to indicate the state/status of the patron table) and/or in a list form (e.g., a list correlating the table with the state/status thereof). The attendant (e.g., host/hostess/manager/employee) at the central station (e.g., a host/hostess station or desk) may, using the state/status information of the patron table(s), make seating decisions and/or route customers accordingly.

As noted above, the handheld device(s) and/or the central station of the restaurant management system may transmit, output and/or provide, via the Internet or other communication network, data corresponding to the state/status and/or change in state/status of one or more, or all of the patron table(s) of a given restaurant to one or more remote processing systems (e.g., one or more servers in the “cloud”). The data corresponding to the state/status and/or change in state/status may be transmitted, outputted and/or provided (via the handheld device(s) and/or the central station), in real-time, periodically (hourly, daily and/or weekly) and/or intermittently. In one embodiment, the remote processing system may generate data analytics using, based on and/or related to data of the (i) status and/or a state of one or more, or all of the patron tables of the restaurant, and/or (ii) change of status and/or state of one or more, or all of the patron tables of the restaurant. Here, the remote processing system may generate analytics, for a given restaurant, corresponding to:
a. state-to-state cycle time of one or more, or all, patron tables (e.g., average state-to-state cycle time—including, for example, on a periodic basis (e.g., daily, weekly, monthly and/or yearly)),
b. average turnaround time of one or more, or all, patron tables (ready state to ready state (i.e., which may be referred to as “table turnover time” or “table turnover optimization”),
c. average time of one or more, or all, patron tables are in a given state (e.g., ready state to ready state, occupied state and/or dirty state—including, for example, on a periodic basis (e.g., daily, weekly, monthly and/or yearly)),
d. average revenue per table relative to (i) state-to-state cycle time and/or (ii) average turnaround time—including, for example, on a periodic basis (e.g., daily, weekly, monthly and/or yearly), and
e. employee productivity (e.g., productivity of one or more, or all, table attendants—for example, on a periodic basis (e.g., daily, weekly, monthly and/or yearly).

The remote processing system may generate such analytics on a table-by-table basis of the restaurant (including in relation to a patron table location or placement on the floor) and/or on the basis of the restaurant as a whole. Notably, the aforementioned data analytics of one, some and/or all of the patron table states, employee productivity, and/or the restaurant as a whole are merely exemplary and not intended to be limited thereto. Any/all data analytic(s) of one, some and/or all of the patron table states, and/or the restaurant as a whole, is/are intended to fall within the scope of the present inventions.

### BRIEF DESCRIPTION OF THE DRAWINGS

The present inventions may be implemented in connection with embodiments illustrated in the attached drawings. These drawings show different aspects of the present inventions and, where appropriate, reference numerals illustrating like structures, components, materials and/or elements in different figures are labeled similarly. It is understood that various combinations of the structures, components, and/or elements, other than those specifically shown, are contemplated and are within the scope of the present inventions.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended to reflect or indicate the embodiment(s) is/are “example” embodiment(s).

The inventions are not limited to the illustrative/exemplary embodiments set forth in this application. Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are neither illustrated nor discussed separately herein.

FIGS. 1A-1D illustrate, in block diagram form, exemplary embodiments of restaurant management systems including a patron table management system to, among other things, generate, transmit/output data which is representative of a status and/or a state of one or more, or all of the patron tables of the restaurant, according to certain aspects of the present inventions, wherein, in one embodiment, the patron table management system includes one or more handheld devices to read or detect a tag indicator (e.g., an NFC tag, an RFID tag, a QR code, a barcode, etc.) having identification data, which is stored or programmed (e.g., one time or more than one time programmable) in the tag indicator, that uniquely identifies each tag indicator and, as such, the patron table associated therewith; the tag indicator may be secured or fixed to a particular patron table of the restaurant (e.g., the tag indicator is secured to the underside of the patron table); in operation, the handheld devices communicate (wirelessly, for example, via an Intranet) directly or through a proxy (such as a shared API, database, etc.) with, for example, a central station (e.g., a host station or desk) wherein the central station receives (e.g., via a Wi-Fi) information regarding the state/status of the patron table; in one embodiment, the central station of the restaurant management system may communicate, via the Internet, to a remote processing system (e.g., one or more servers in the “cloud”) to, for example, generate data analytics using, based on and/or related to data of the (i) status and/or a state of one or more, or all of the patron tables of the restaurant, and/or (ii) change of status and/or state of one or more, or all of the patron tables of the restaurant (see, e.g., FIG. 1B); indeed, in one embodiment, the handheld device(s) of the restaurant management system may, in addition to the central station, or in lieu thereof, transmit, output and/or provide (e.g., in real-time), via the Internet or other communication network, data corresponding to the state/status and/or change in state/status of one or more, or all of the patron table(s) of a given restaurant directly to one or more remote processing systems (e.g., one or more servers in the “cloud”) (see FIGS. 1C and 1D); and, in another embodiment, the one or more remote processing systems may receive the (i) status and/or a state of one or more, or all of the patron tables of the restaurant, and/or (ii) change of status and/or state of one or more, or all of the patron tables of the restaurant from the handheld device(s) (e.g., in real-time) and, thereafter, transmit, output and/or provide (e.g., in real-time) such information/data, via the Internet or other communication network to the central station to, for example, make seating decisions at patron tables, and/or route customers/patrons, and/or manage customer/patron experience—wherein, in this embodiment, the central station receives the information/data from the remote processing system(s) (see FIG. 1D);

FIGS. 2A-2D illustrate, in block diagram form, exemplary embodiments of handheld devices of a patron table management system to, for example, detect and/or read the unique identifier of a tag indicator (e.g., read the NFC tag and/or detect the RFID signal emitted by the RFID tag) that is affixed to a patron table to uniquely identify the patron table in the restaurant, according to certain aspects of the present inventions; the handheld device includes a tag reader, which may optically, inductively and/or electronically detects and/or reads (wirelessly) the unique identification data (e.g., stored (permanently or temporarily) and/or programmed) in the tag indicator; handheld device also includes communication circuitry (e.g., a wireless transmitter) to: (i) output, transmit and/or provide data which is representative of the patron table associated with the tag indicator that is, for example, affixed thereto, and read/detected by the tag reader of the handheld device, and, in one embodiment, output, transmit and/or provide (ii) data which is representative of the state/status of that particular patron table, and/or change thereof; in one embodiment, the handheld device includes a display to provide or present information (e.g., table status and/or change therein) to the table attendant (see, e.g., FIGS. 2A and 2B) and a user interface having an input mechanism (for example, a touch screen overlay for a display and/or buttons, wherein the user may input data and/or commands) and/or an output mechanism (for example, physical (e.g., haptic vibration device) (see, e.g., FIGS. 2B and 2C);

FIGS. 3A-3F are block diagram representations of exemplary user interface embodiments of the exemplary handheld devices according to certain embodiments of the handheld device of the present inventions; in these exemplary illustrative embodiments, the user interface may include one or more input mechanisms/devices (for example, a touch screen overlay for a display, keypad/button(s), knob(s), switch(es), microphone, and/or gesture recognition sensor(s), wherein the user may input data and/or commands) and/or one or more output mechanisms/devices (for example, physical (e.g., haptic vibration device), audio (e.g., speaker/buzzer) and/or visual (e.g., illumination such as LED(s)); notably, any manner of and/or mechanism/device for outputting and/or inputting of data and/or commands (for example, responses to, for example, queries) are intended to fall within the scope of the present inventions;

FIGS. 4A-4C illustrate, in block diagram form, exemplary embodiments of central stations of a patron table management system of the restaurant management systems, according to certain embodiments of the central station of the present inventions; wherein the central station includes communication circuitry to receive the state/status, and/or change therein, of each patron table of the restaurant, via one or more handheld devices that output or transmit the state/status, and/or change in state/status, of a particular patron table of the restaurant, via reading or detecting the unique identifier of the tag indicator (which is stored or programmed in the tag indicator); in one embodiment, the display of the central station provides information of the state/status of one or more, or all, of the patron table of the restaurant wherein such information may be presented to and/or organized for a host/hostess to manage the flow and/or experience of patrons;

FIGS. 5A-5D illustrate exemplary screen images output by a display of the central station wherein in one embodiment, the display depicts each patron table graphically, for example, in “map” or floor plan layout form (see, FIGS. 5A and 5C), and the status or state (and/or changes therein) according to a designated color (e.g., a floor plan including, for example, a color coded symbol for each patron table wherein each symbol (e.g., a table) is located relative to each in a layout representative of the location of each patron table on the restaurant floor, and a color to indicate the state/status of the patron table) (see, FIG. 5A) or, in addition thereto, or in lieu thereof, text (see, FIG. 5C) may be displayed to reflect the state/status of the patron table (e.g., “Clean”, Dirty” or “Occupied” or a text symbols reflecting the various states/statuses); in another embodiment, the display depicts each patron table in a list form (e.g., a list correlating to each patron table in the restaurant state/status) FIGS. 5B and 5D), and the status or state (and/or changes therein) according to a designated color wherein a color code to reflect the state/status of the patron table (see, FIG. 5B), or, in addition thereto, or in lieu thereof, text (e.g., “Clean”, Dirty” or “Occupied” or a text symbols reflecting the various states/statuses) may be displayed to reflect the state/status of the patron table (see, FIG. 5D); such information to is available an attendant (e.g., host/hostess/manager/employee) at the central station (e.g., a host/hostess station or desk); in each instances, the information is available to make seating decisions at patron tables, and/or route customers/patrons, and/or manage customer/patron experience; notably, the central station may generate state or status (and/or changes therein) of each patron table using or based on information received from one or more handheld devices;

FIGS. 6A and 6B illustrate, in block diagram form, exemplary embodiments of a handheld device, via the tag reader, wirelessly reading or detecting (e.g., optically, inductively and/or electronically) the unique identifier of the tag indicator that is disposed on and/or affixed to a patron table, according to certain aspects of the present inventions, wherein the tag indicator—tag reader interaction, when the tag reader of the handheld device is within an operable range, may be uni-directional (FIG. 6A) or bi-directional (FIG. 6B);

FIGS. 7A-7C illustrate, in graphical form, exemplary embodiments of sequences of a patron table state/status (and/or change therein), according to certain aspects of the present inventions, wherein a sequence may include two or more states/statuses, for example, the sequence, which may be predetermined, fixed or predefined, includes: (i) “ready” wherein a patron table is clean and ready to be occupied by patron(s)), (ii) “seated” wherein patron(s) seated at a table (i.e., patron(s) occupy a particular table), and (iii) “dirty” wherein the patron table is dirty, for example, from the immediately previous patron(s) (see, e.g., FIG. 7A); in another embodiment, the sequence of the state/status of the patron table (which again may be predetermined/predefined) may further include a state/status of “cleaning” (i.e., an attendant is in the process of cleaning the table to prepare the table to be occupied by patron(s)) (see, e.g., FIG. 7B); in yet another embodiment, the predetermined/predefined sequence of the states/statuses of the patron table may include two states including, for example, (i) “ready” wherein a patron table is clean and ready to be occupied by patron(s)) and (ii) “seated” wherein patron(s) seated at a table (i.e., patron(s) occupy a particular table) (see, e.g., FIG. 7C); notably, the system may employ one or more predetermined/predefined sequences of states, the aforementioned sequence of states of the patron table are merely exemplary—any order sequence(s) now known or later developed are intended to fall within the scope of the present inventions; moreover, the restaurant management system may employ one or more predetermined/predefined sequences of states having any state, any order of states, any number of states/statuses (i.e., two or more) in a sequence, and/or any order of states/status in the sequence(s);

FIGS. 8A-8C illustrate, in block diagram form, exemplary embodiments of selected stages of data extraction and transmission of certain exemplary embodiments of the present inventions, wherein the unique identifier information of the tag indicator (which is associated with a given patron table) is extracted, read, scanned and/or detected by the handheld device and is transmitted to the central station and/or remote system(s); in one embodiment, the state/status of that patron table is thereafter automatically changed to the next state/status of a predetermined/predefined sequence of the states/statuses of the patron table based on, for example, wherein the unique identifier information of the tag indicator (see FIG. 8A); in another embodiment, the state/status of that patron table is changed to a different state/status based on an input from the table attendant (e.g., after cleaning, the table attendant may change the status of the patron table to clean/ready), for example, via the touch display (e.g., selection/tap of the “updated” state/status from a plurality of state/status tiles presented on the display on the handheld device (FIG. 8B) or a selection of the “updated” state from a pull-down menu presented on the display of the handheld device (see FIG. 8C) wherein the unique identifier information of the tag indicator as well as a state/status of the associated patron table is output or transmitted to, for example, the central station and/or a remote processing system; as noted above, the tag indicator—tag reader interaction may be bi-directional communication (e.g., when reading an NFC or RFID tag), when the tag reader of the handheld device is within an operable range, or uni-directional only (e.g., when reading a QR code);

FIGS. 9A-9D illustrate, in block diagram form, exemplary embodiments of systems communication between the handheld device(s), the central station(s) and, in certain embodiments, one or more remote systems, according to certain aspects of the present inventions; and

FIGS. 10A-10D illustrate, in block diagram form, exemplary embodiments of hotel management systems including a housekeeping/cleaning management system to, among other things, generate, transmit/output (i) a status and/or a state of one or more, or all of the guest rooms of the hotel, according to certain aspects of the present inventions, wherein, in one embodiment, the housekeeping/cleaning management system includes one or more handheld devices to read or detect a tag indicator (e.g., an NFC tag, an RFID tag, a QR code, a barcode, etc.) associated with a guest room, wherein the tag indicator includes identification data, which is stored or programmed (e.g., one time or more than one time programmable) in the tag indicator, that uniquely identifies each tag indicator and, as such, the guest room associated therewith; the tag indicator may be located in and/or secured or fixed to or near a particular guest room of the hotel (e.g., the tag indicator is secured to a wall in the guest room); in operation, the handheld devices communicate (via wirelessly, for example, via an Intranet) directly or through a proxy (such as a shared API, database, etc.) with, for example, a central station (e.g., a housekeeping desk and/or front desk) wherein the central station receives (e.g., via a Wi-Fi) information regarding the state/status of the guest room; in one embodiment, the central station of the hotel management system may communicate, via the Internet, to a remote processing system (e.g., one or more servers in the “cloud”) to, for example, generate data analytics using, based on and/or related to data of the (i) status and/or a state of one or more, or all of the guest rooms of the hotel, and/or (ii) change of status and/or state of one or more, or all of the guest rooms of the hotel (see, e.g., FIG. 10B); indeed, in one embodiment, the handheld device(s) of the restaurant management system may, in addition to the central station, or in lieu thereof, transmit, output and/or provide (e.g., in real-time), via the Internet or other communication network, data corresponding to the state/status and/or change in state/status of one or more, or all of the guest room(s) of a given hotel directly to one or more remote processing systems (e.g., one or more servers in the “cloud”) (see FIGS. 10C and 10D); and, in another embodiment, the one or more remote processing systems may receive the (i) status and/or a state of one or more, or all of the guest room of the hotel, and/or (ii) change of status and/or state of one or more, or all of the guest rooms of the hotel from the handheld device(s) (e.g., in real-time) and, thereafter, transmit, output and/or provide (e.g., in real-time) such information/data, via the Internet or other communication network to the central station to, for example, make room availability decisions of newly arriving guests and/or manage the guest/customer experience—wherein, in this embodiment, the central station receives the information/data from the remote processing system(s) (see FIG. 10D); it should be noted that the embodiments and features of the devices, systems, implementations, processes and/or components described above in the context of the restaurant management system and/or table management system (e.g., FIGS. 2A-9D) are entirely applicable to the hotel management system and/or housekeeping/cleaning management system; for the sake of brevity, such discussion will not be repeated in the context of the housekeeping/cleaning management system; moreover, the present inventions are applicable to similar services in connection with commercial building including, for example, janitorial or cleaning services wherein, for example, a commercial building having a plurality of restrooms or customer/public areas require or implement cleaning services; thus, in the context of commercial building, the drawing identifier “Guest Room” (e.g., “Guest Room 1”) would be labeled “Restroom” (e.g., “Restroom 1”) or “Customer/Public Area” (e.g., “Customer/Public Area 1”).

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed or illustrated separately herein.

### DETAILED DESCRIPTION

In one aspect, the present inventions are directed to devices and systems of, and methods implemented by, a restaurant management system including a patron table management system to input, generate, transmit/output (i) a status and/or a state of one or more, or all of the patron tables of the restaurant, and/or (ii) a change or an update of a status and/or a state of one or more, or all of the patron tables of the restaurant. For example, the status and/or a state of a patron table of the restaurant may be one or more (or all) of the following: table occupied or patron(s) seated (i.e., patron(s) occupy the table), clean/ready (i.e., the patron table is clean and ready to be occupied by patron(s)), table dirty (the table is dirty, for example, from the immediately previous patron(s)), and/or cleaning in process (i.e., an attendant is in the process of cleaning the table to prepare the table to be occupied by patron(s)). Notably, these aforementioned states/statuses of the patron table are merely exemplary wherein other/different/additional table states may be employed.

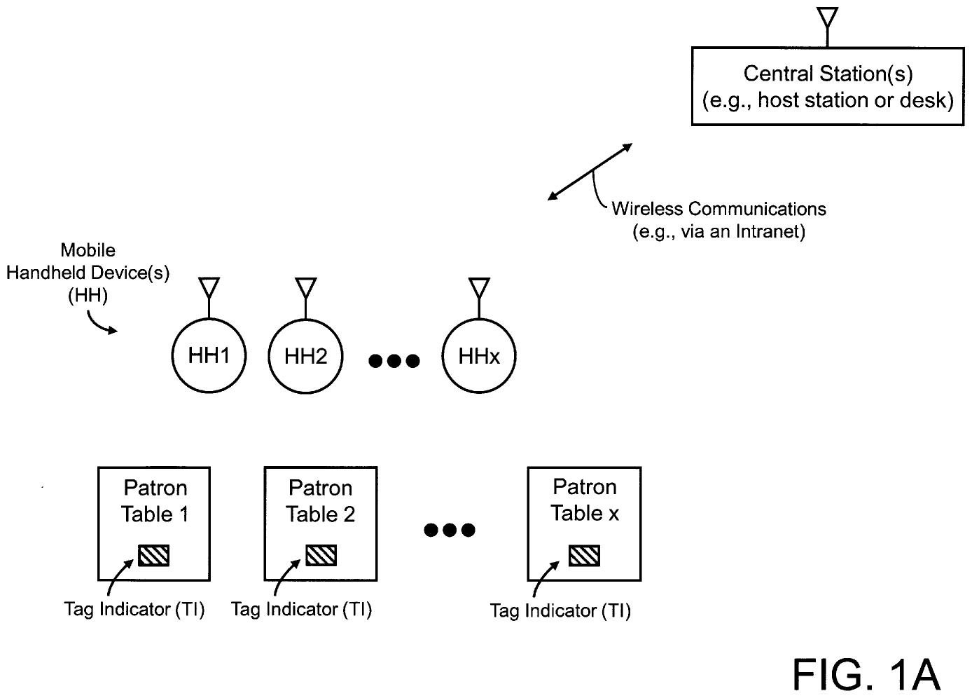

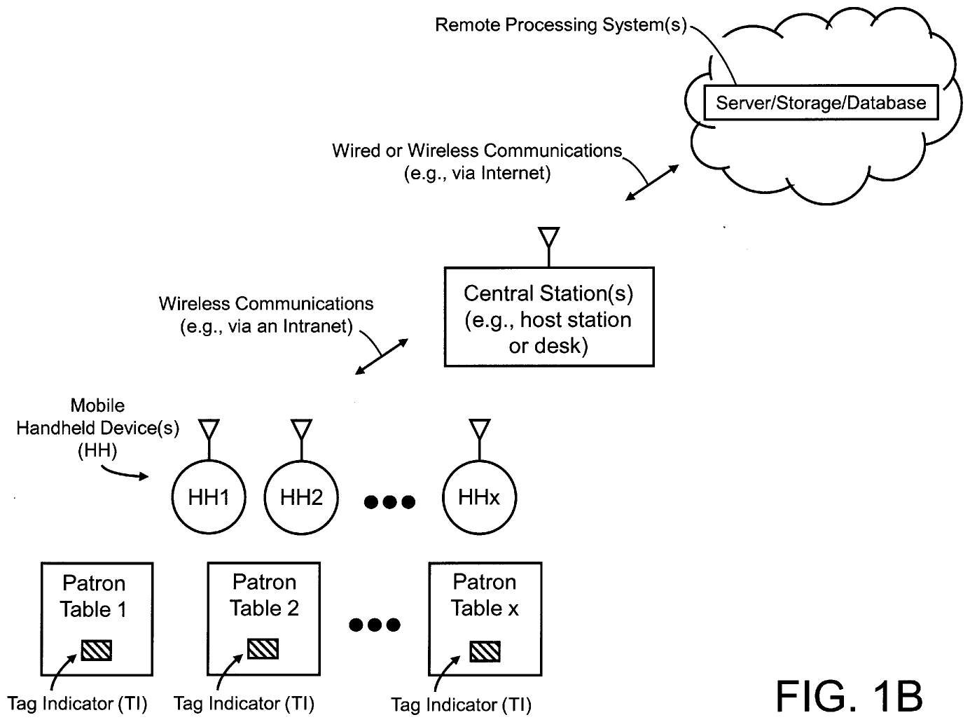

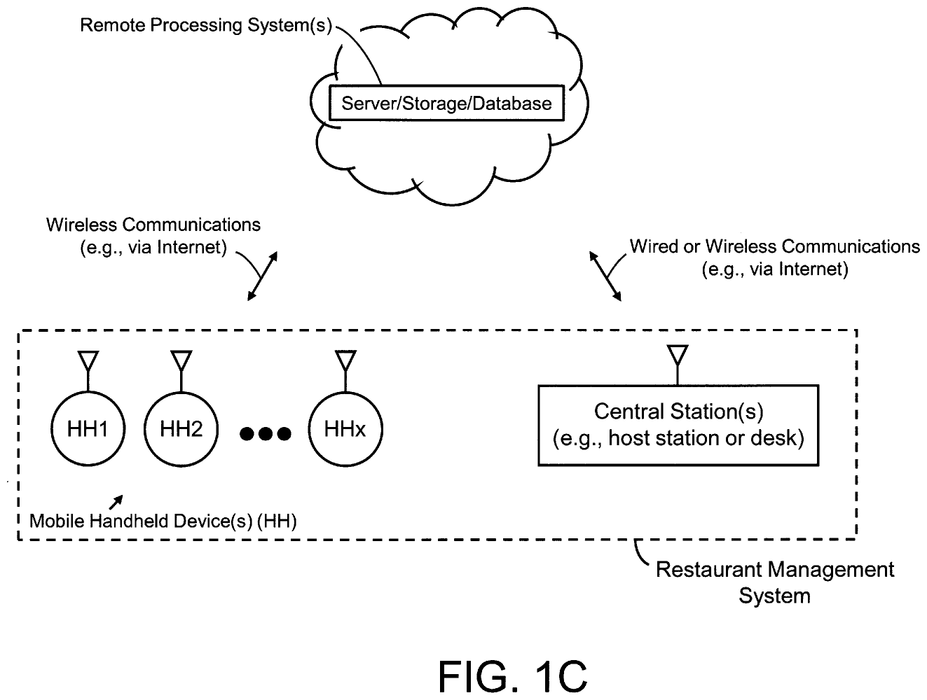

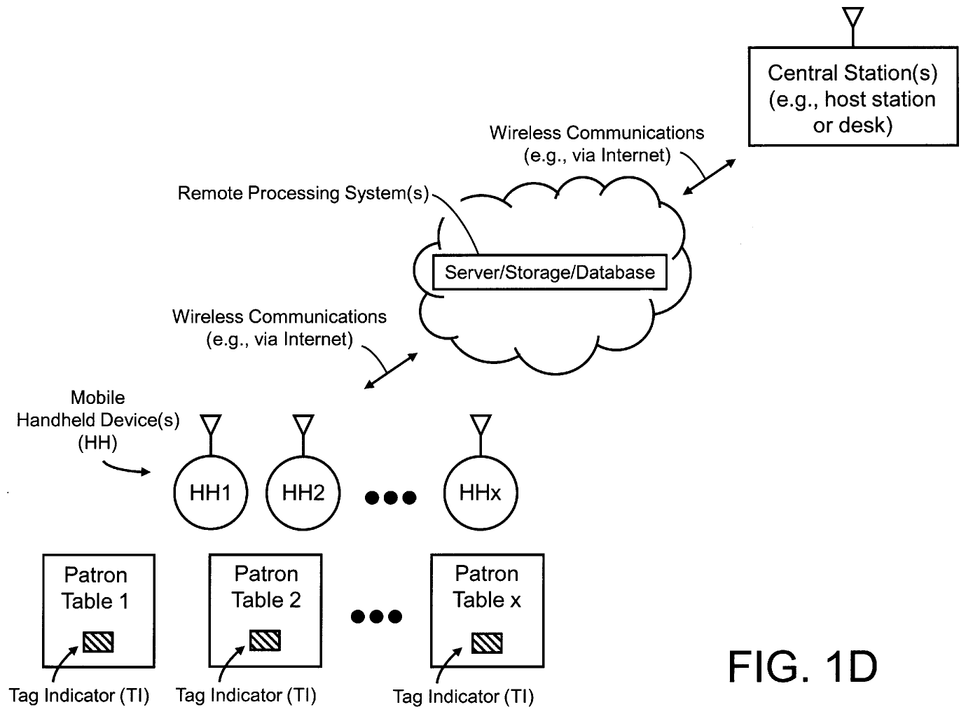

With reference to FIG. 1A, in one embodiment, the patron table management system includes a plurality of tag indicators, each tag indicator (e.g., an NFC tag, an RFID tag, a QR code, a barcode, etc.) is associated with a particular patron table. The tag indicator includes identification data, which is stored or programmed in the tag indicator, that uniquely identifies the tag indicator. The identification data of the tag indicator may be wirelessly detected and/or read—for example, optically, inductively and/or electronically. In one embodiment, the tag indicator is secured or fixed to a given or particular patron table of the restaurant (e.g., each tag indicator is secured to the underside of a different one of the patron tables). As such, each tag indicator, which is associated with a different patron table, uniquely and specifically identifies the patron table to which the tag indicator is disposed thereon/therein, secured and/or affixed, and associated therewith, via the identification data which is stored or programmed in the associated tag indicator.

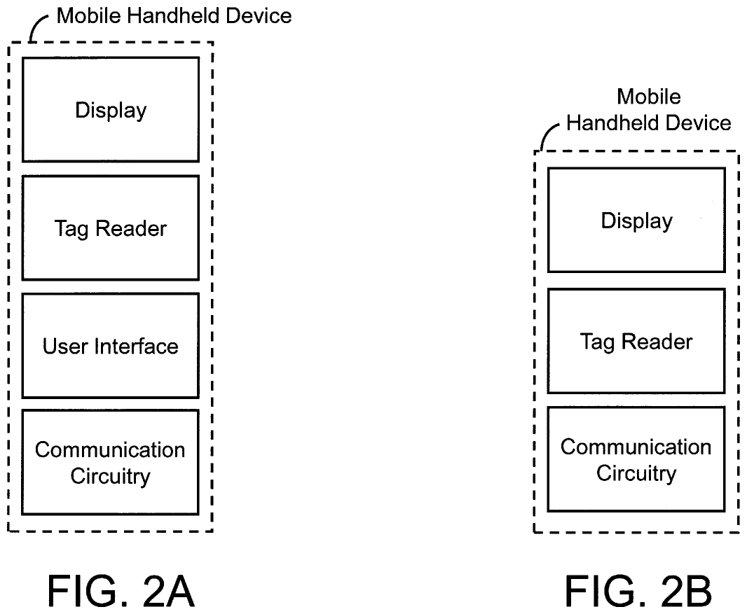

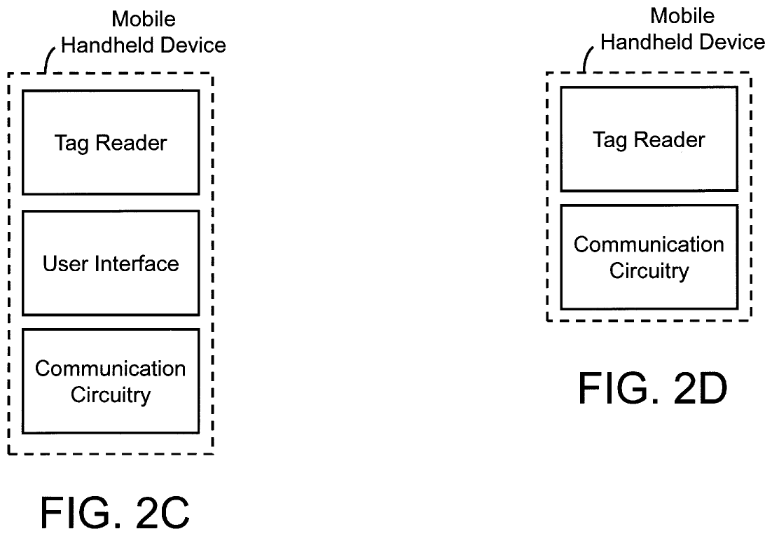

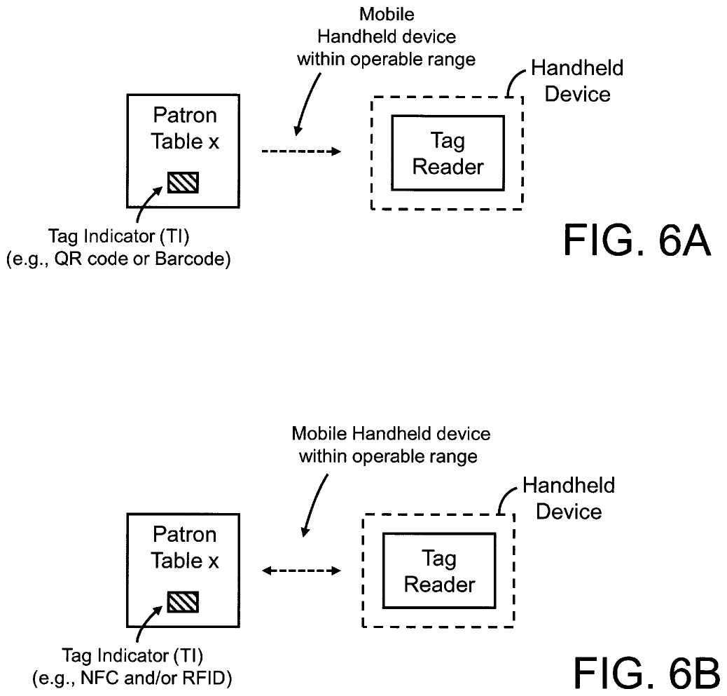

With reference to FIGS. 1A and 2A, the patron table management system also includes one or more handheld devices—each handheld device including communication circuitry (e.g., a wireless transmitter) and detection circuitry to read a tag indicator (hereinafter the detector or reader collectively referred to as “tag reader”) to detect and/or read the unique identifier of the tag indicator (e.g., read a QR code or barcode (see FIG. 6A) and/or read/detect the signal emitted from an NFC tag and/or an RFID tag of the tag indicator (see FIG. 6B)) that is disposed thereon/therein, secured and/or affixed to the patron table. In this regard, the tag reader of the handheld device, when located within an operable range (e.g., in the context of NFC, 10 cm), optically, inductively and/or electronically detects and/or reads (wirelessly) the identification data (unique identification data) of the tag indicator which is disposed in/on, secured or affixed to the particular patron table and, as such, identifies the particular/specific patron table associated therewith. (See, e.g., FIGS. 6A and 6B). Thereafter, the communication circuitry (e.g., wireless transmitter) of the handheld device outputs, transmits and/or provides (via an Intranet and/or the Internet) data which is representative of a status and/or a state of the patron table (and/or a change or an update of a status and/or a state of the patron table) associated with the unique identifier of the tag indicator (secured or affixed to that patron table) that is detected or read by the handheld device. In one embodiment, the communication circuitry of the handheld device outputs, transmits and/or provides such data to, for example, a central station (e.g., a host/hostess station or desk) of the restaurant management system.

With continued reference to FIGS. 1A and 2A, the handheld device, in one embodiment, includes a display and a user interface (e.g., touch-screen type, haptic device, and/or keypad). Where the handheld device is operated by a table attendant (e.g., an individual and/or restaurant employee who is responsible for cleaning, bussing and/or setting/re-setting the patron table), during maintaining/managing the patron table or state of the patron table, the table attendant may interact with the display and user interface to input and/or select the data which is representative of a status and/or a state of the patron table (and/or a change or an update of a status and/or a state of the patron table) and/or output, transmit and/or provide such data to, for example, a central station (e.g., a host/hostess station or desk) of the restaurant management system.

For example, in operation, the table attendant accesses the unique identifier of the tag indicator of an associated table via the tag reader of the handheld device (e.g., positioning the detector/reader of the handheld device in operable proximity (optically, inductively or electronically) of a QR code or bar code of, on and/or in the tag indicator (see, FIG. 6A) and/or NFC tag or RFID tag of the tag indicator (see FIG. 6B)). In one embodiment, in response to accessing the identification data (unique identification data) of the tag indicator, the handheld device may display a plurality of states/statuses for that particular patron table (e.g., a plurality (or all) of those states/statuses discussed above) and await/request the table attendant to select or enter the state/status of the patron table associated with the tag indicator (e.g., a new state/status of the patron table or change in current state/status of the patron table). In one embodiment, the handheld device may display a pull-down menu wherein the table attendant may select/input the appropriate state/status according to the state/status of the patron table associated with the tag indicator (e.g., “clean/ready” (i.e., the patron table is clean and ready to be occupied by patron(s)) after the table attendant has serviced (cleaned and set) the patron table). For ease of operation and to facilitate uniformity of selection/input of the state/status of a patron table, the pull-down menu may present the table attendant with all of the possible states/statuses or a limited number of options to select/input/confirm (for example, limited based on the previous state/status of the patron table).

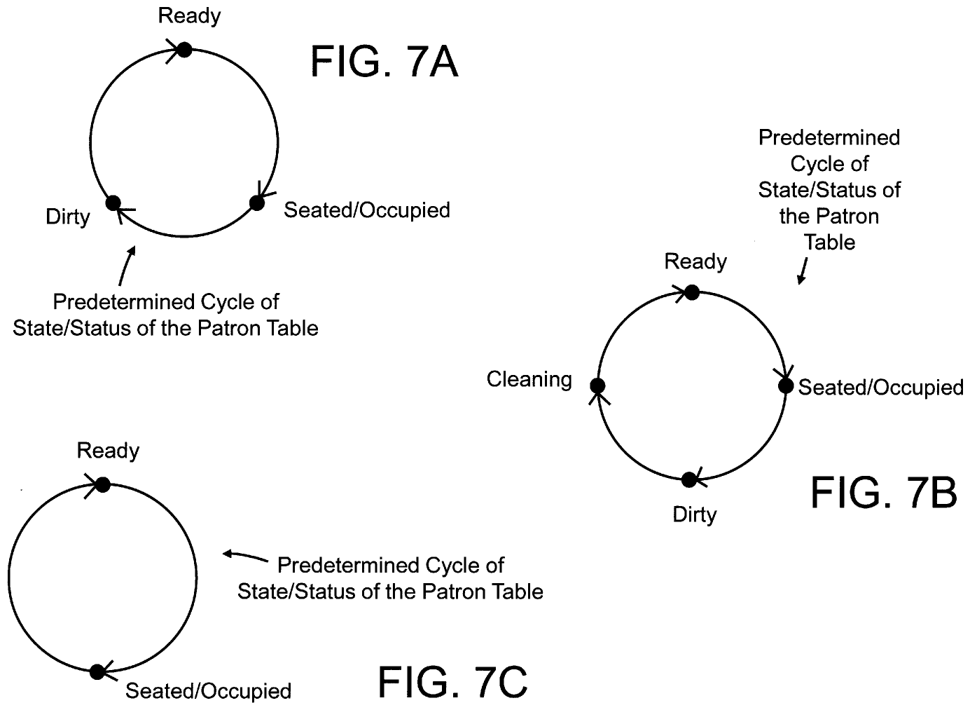

With reference to FIGS. 1A and 2B, in one embodiment, the handheld device includes a display, in addition to a communication circuitry (e.g., a wireless transmitter) and a tag indicator detector or reader (hereinafter collectively “tag reader”), and associated electronics, but does not include a user interface. As such, in operation, a table attendant may “input” or “select” as well as output data which is representative of a status and/or a state of the patron table (and/or a change or an update of a status and/or a state of the patron table) to, for example, a central station (e.g., a host/hostess station or desk) of the restaurant management system via positioning or locating the tag read of the handheld device in an operable range, optically, inductively and/or electronically to detect and/or read (wirelessly) the identification data (unique identification data) of the tag indicator that identifies the particular/specific patron table associated therewith. In response, the communication circuitry of the handheld device transmits data which is representative of the tag indicator's unique identification data—which correlates to a particular/specific patron table. The central station, upon receipt of the data, may (automatically and/or without further input or data from the handheld device) interpret receipt thereof as a new state/status of the patron table and/or a change or an update of a status and/or a state of the patron table. In response, in one embodiment, the central station changes or updates the state/status of that patron table to a next state/status based on (i) the current state/status of the patron table—which may be known to, maintained and/or stored in the central station and (ii) a predetermined/predefined sequence of the state/status and/or change in state/status of the patron table (see, e.g., FIGS. 7A-7C). Notably, the display of the handheld device may provide feedback (e.g., via a haptic device) to the table attendant that the central station has received the data and/or has registered an update in the state/status of the particular patron table.

With reference to FIGS. 1A and 2C, in another embodiment, the handheld device includes a user interface, in addition to a communication circuitry (e.g., a wireless transmitter) and a tag reader, and associated electronics—but does not include a display. Here, the user interface may include one or more physical (e.g., haptic vibration device), audio (e.g., speaker/buzzer), and/or visual (e.g., illumination such as LED(s)) feedback device(s). As such, a handheld device of this exemplary embodiment may be suitable for limited interaction between the table attendant (via the handheld device) and the central station wherein the table attendant need not specifically select/input a patron table state/status (and/or change therein) via, for example, a display (e.g., touch-screen type) and/or keypad. Rather, upon accessing the tag indicator of an associated patron table via the tag reader of the handheld device, the handheld device communicates (via wireless transmitter of the handheld device) data which is representative of the particular/specific patron table (e.g., communicates the identification data (unique identification data) of the tag indicator that identifies the particular/specific patron table) to the central station. The central station, upon receipt of the data which is representative of the particular/specific patron table, may (automatically and/or without further input or data from the handheld device) interpret receipt thereof as a new state/status of the patron table and/or a change or an update of a status and/or a state of the patron table. In response, in one embodiment, the central station may change or update the state/status of that patron table to a next state/status based on (i) the current state/status of the patron table—which may be known to, maintained and/or stored in the central station and (ii) a predetermined/predefined sequence of the state/status and/or change in state/status of the patron table (see, e.g., FIGS. 7A-7C). As for the handheld device, the physical feedback device (e.g., haptic vibration device), audio feedback device (e.g., speaker/buzzer) and/or illumination (e.g., LED(s)) feedback device may notify or provide feedback to the table attendant that the restaurant management system (e.g., the central station) has received, acknowledges and/or has registered an updated state/status via accessing the tag indicator.

With reference to FIGS. 1A and 2D, in yet another embodiment, the handheld device may include a tag reader and communication but neither a display nor a user interface. Here, the tag reader of the handheld device is configured to optically, inductively and/or electronically detect and/or read (wirelessly) the identification data of the tag indicator that uniquely identifies the patron table associated therewith, and communication circuitry of the handheld device is configured to output, transmit and/or provide the state/status and/or change in state/status of a patron table. Upon accessing the tag indicator of an associated patron table via the tag reader, the handheld device communicates data which is representative of the patron table associated with the tag indicator to the central station. Similar to the embodiments immediately above, in response, the central station may change or “update” the state/status of that patron table to predefined/predetermined next state/status of the patron table based on (i) a predetermined/predefined sequence of the state/status and/or change in state/status of the patron table (see, e.g., FIGS. 7A-7C) and (ii) the current state/status of the patron table—which, in one embodiment, is known to, maintained and/or stored in the central station. In this embodiment, there may be no feedback to the table attendant from the central station of receipt of a change of or “update” to the state/status of the patron table associated with the tag indicator that was read by the tag reader of the handheld device.

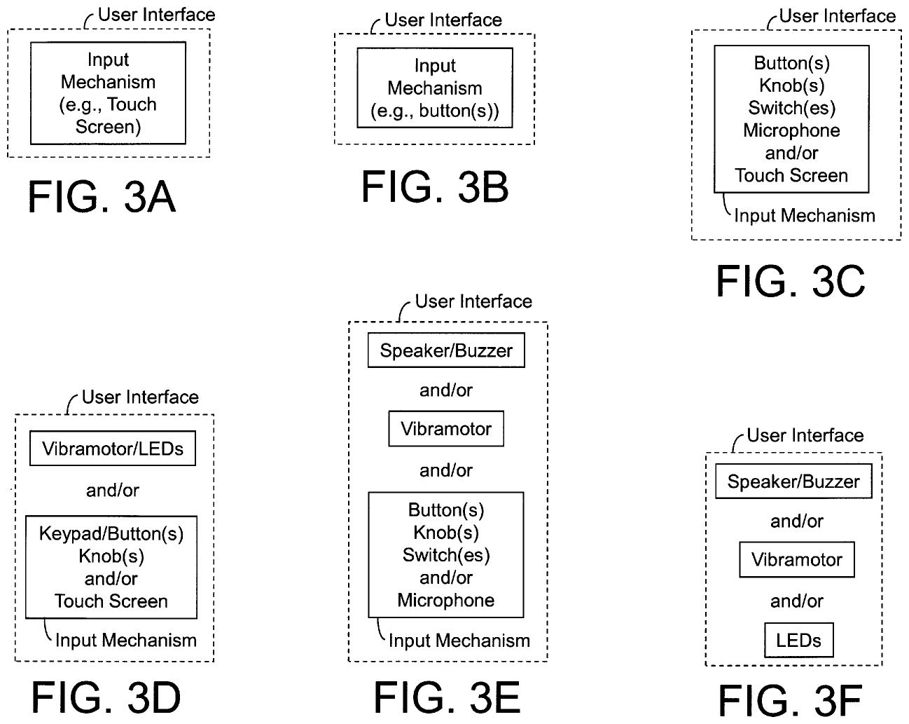

With reference to FIGS. 3A-3F, the user interface of the handheld device may include one or more input mechanisms/devices (for example, a touch screen overlay for a display, keypad/button(s), knob(s), switch(es), microphone, and/or gesture recognition sensor(s), wherein the user may input data and/or commands). In another embodiment, the user interface may include one or more output mechanisms/devices (for example, physical (e.g., haptic vibration device such as a vibramotor), audio (e.g., speaker/buzzer) and/or visual (e.g., illumination such as LED(s)). In operation, a table attendant may “input” or “select” as well as output data which is representative of a status and/or a state of the patron table (and/or a change or an update of a status and/or a state of the patron table) to, for example, the central station of the restaurant management system. In response, the communication circuitry may transmit the data of the read/detection of the identification data of the tag indicator. The user interface may include mechanisms/devices to provide (i) feedback to the table attendant of receipt of the data by the central station and/or (ii) other information or requests (e.g., verification of the table state/status) in connection with operation of the system. Notably, any manner of and/or mechanism/device for outputting and/or inputting of data and/or commands (for example, responses to, for example, queries) are intended to fall within the scope of the present inventions.

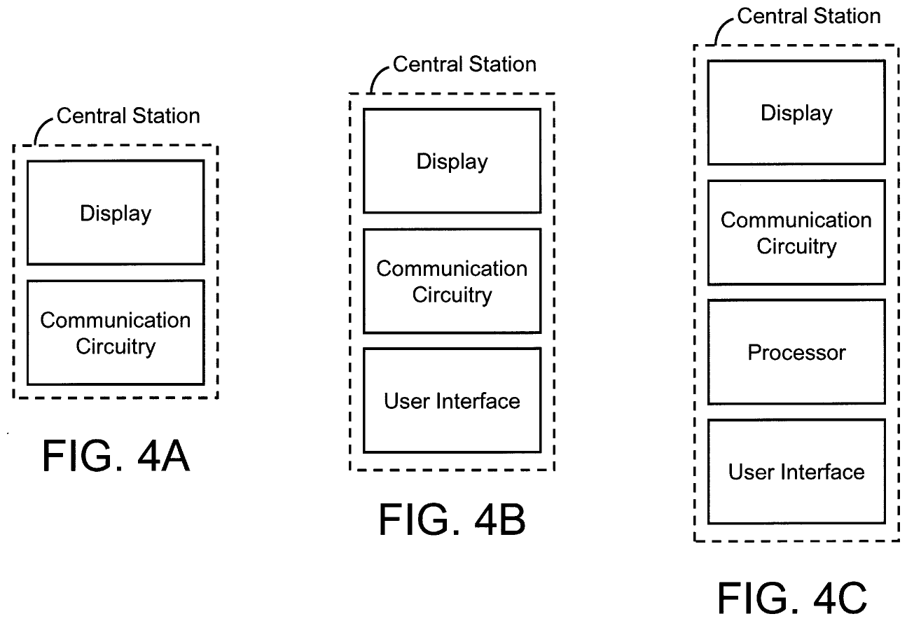

With reference to FIGS. 1A and 4A-4C, the central station of the restaurant management system includes communication circuitry (e.g., wireless receiver) to receive data which is representative of the state/status, and/or change therein, of the patron table(s) of the restaurant, via the tag reader of each handheld device that reads or detects the tag indicator associated with a particular patron table. The communication circuitry of the handheld device outputs or transmits data of the tag indicator read by the tag reader to the central station. In one embodiment, the central station may correlate that transmitted/received data to the patron table associated with the tag indicator.

In one embodiment, the handheld device transmits a state/status of the patron table (and/or change therein) in addition to the identification data of the tag indicator associated with that patron table. In another embodiment, the handheld device transmits the identification data of the tag indicator associated with that patron table and the central station, using that information, determines a state/status of the patron table (and/or change therein).

Notably, the handheld device, central station and/or remote system(s) may be configured to verify a new or change in state/status of the patron table to, for example, maintain integrity of the data (e.g., the accuracy of the state/status of each patron table). In one embodiment, the handheld device may display a warning to the table attendant and/or request confirmation of the state/status of the patron table wherein the handheld device may provide an opportunity to undo or override a state/status of the patron table before transmission to the central station. In addition thereto, or in lieu thereof, in one embodiment, the central station, after receipt of a status/status of (and/or change therein) a patron table (via the handheld device) may display a warning to the table attendant and/or request confirmation of the state/status of the patron table. In response thereto, the table attendant may correct or confirm the state/status of the patron table. For example, with a system of states of clean/ready, occupied/seated, and dirty, where a dirty table is cleaned and occupied/seated promptly. Rather than reading the tag indicator twice, the user of the handheld device may choose the current state of occupied/seated and override the warning message that “clean/ready” was skipped. In this way, the system will keep a cyclical nature of the stat/status changes by considering the “clean/ready” state to have been “instantaneous.”

The central station (e.g., a host/hostess station or desk) may also include a display to provide information of the state/status of one or more, or all, of the patron table of the restaurant to, for example, manage the flow and/or experience of patrons. In operation, as the central station receives data which is representative of the state/status, and/or change in state/status, of a particular patron table, the central station provides that information to the host/hostess or manager via the display. That is, in one embodiment, the central station generates display information based on the state/status (and/or changes therein) of each patron table of the restaurant using and/or based on information received from the handheld devices.

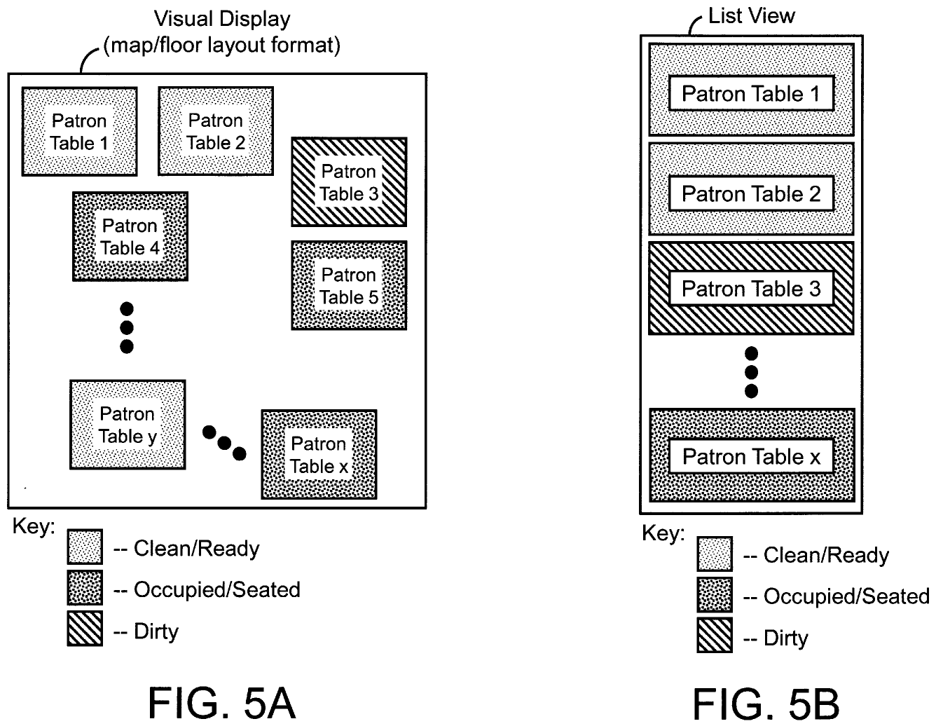

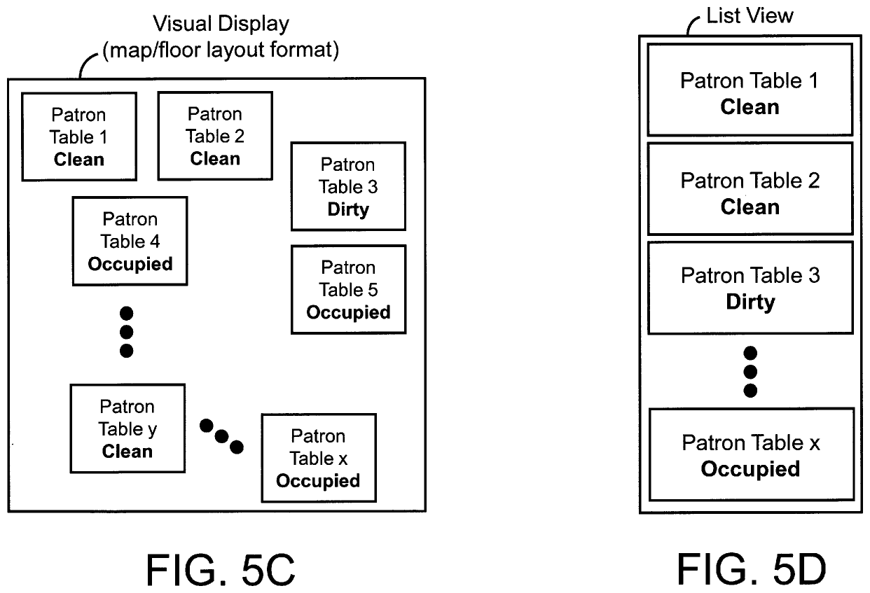

With reference to FIG. 5A, in one embodiment, the display of the central station depicts each patron table of the restaurant graphically in “map” or floor plan layout of the restaurant. For example, the central station illustrates each patron table on the display according to its location thereof in the restaurant—that is the location of the table on the “floor” or in the restaurant's floor plan. In addition, the central station may depict the state/status of each patron table in a coded manner such as a color code—for example, clean/ready is represented in green (that is, all patron tables that are in a clean/ready state are represented in green), occupied/seated is represented in blue (that is, all patron tables that are in an occupied/seated state are represented in blue), and dirty is represented in red (that is, all patron tables that are in a dirty state are represented in red). As such, in one embodiment, the central station displays the patron table and state/status thereof graphically in “map” or floor plan layout form wherein each table is color coded according to the state/status thereof. Here, the central station, in operation, changes the color of each table based on and in accordance with the state/status of the patron table and/or changes in the state/status of the patron table. In this way, the state/status of the patron table is presented on the display and available to an attendant (e.g., host/hostess/manager/employee) at the central station (e.g., a host/hostess station or desk)—which may improve the table management of restaurant as well as the flow and/or experience of the patrons in the restaurant.

With reference to FIG. 5B, in another embodiment, the display depicts the state or status (and/or changes therein) of each patron table in a list form (e.g., a list correlating the table with the state/status thereof). In one embodiment, the central station depicts the state/status of each patron table in the list according to a code—for example, color code (e.g., patron tables that are in a clean/ready state are represented in green, patron tables that are in an occupied/seated state are represented in blue, and patron tables that are in a dirty state are represented in red). Again, the central station, in operation, updates the state/status of each patron table of the restaurant in accordance with data received from the handheld devices (e.g., in one embodiment, the identification data of the tag indicator associated with a patron table and a state/status of the table (and/or change therein) associated with that table (e.g., as input/selected by the table attendant)). The update of the status of a patron table, in one embodiment, would result in a change in the color of the patron table in the list.

With reference to FIGS. 5C and 5D, in addition to color coding the state/status of each table as described above, or in lieu thereof, the central station may employ text or text symbols (e.g., “Clean”, Dirty” or “Occupied” and/or “C”, “D”, or “O”, and/or other symbols) to reflect the various states/statuses of the patron tables of the restaurant. That is, the central station, via the display, may present the state/status of each patron table in the restaurant via text or text symbol (in lieu of color, or in addition to color). Again, the central station generates display information based on and/or using data/information received from the handheld devices (e.g., identification data of the tag indicator associated with a patron table and the state/status (and/or changes therein) of the patron table associated therewith). Notably, in one embodiment, the host/hostess may manually implement and/or override a state/status (and/or change in) of a patron table directly via the central station (e.g., via the user interface thereof). Regardless, the state/status of each patron table of the restaurant may be presented on the display of the central station (in floor map form or list form) and updated/changed in near real-time (as the patron table is serviced and/or observed by the table attendant and read/detected by the handheld device). Moreover, such information is available to an attendant at the central station (host/hostess station or desk) to observe/understand the current state/status of each patron table individually, and the restaurant as a whole, and thereby improve the table management of restaurant, as well as the flow and/or experience of the patrons.

Notably, in one embodiment, the central station may also include communication circuitry (e.g., a wireless transmitter) to communicate with a handheld device. For example, with reference to FIG. 1A, the central station may, in response to receiving, from a handheld device, data which is representative of a state or status (and/or changes therein) of a given patron table (associated with the tag indicator that is/was read by the tag reader of the handheld device), the central station may transmit a request for confirmation of a state or status (and/or changes therein) of the given patron table. The handheld device may receive the request, via communication circuitry, and the table attendant operating the handheld device may respond to such request via the user interface (see, e.g., FIGS. 3A-3E). Upon confirmation, the central station generates a change in the state/status of that patron table which is thereafter (e.g., immediately thereafter) depicted on the display of the central station. In this way, the central station, via a display, provides information of the state/status of one or more, or all, of the patron table of the restaurant and such information may be presented to and/or organized for a host/hostess to manage the flow and/or experience of patrons

With reference to FIG. 1B, the central station may also include communication circuitry (wireless or wired) to output, transmit and/or provide (via an Intranet and/or Internet) data to one or more remote processing systems. In one embodiment, the central station of the restaurant management system may communicate, via the Internet, to a remote processing system (e.g., one or more servers in the “cloud”) to, for example, generate data analytics using, based on and/or related to data of the (i) status and/or a state of one or more, or all of the patron tables of the restaurant, and/or (ii) change of status and/or state of one or more, or all of the patron tables of the restaurant.

With reference to FIGS. 1C and 1D, in addition thereto, or in lieu thereof, in another embodiment, the handheld device(s) of the restaurant management system may transmit, output and/or provide, via the Internet or other communication network, data which is representative of and/or corresponding to the state/status and/or change in state/status of one or more, or all of the patron table(s) of a given restaurant to one or more remote processing systems (e.g., one or more servers in the “cloud”). The data representative of and/or corresponding to the state/status and/or change in state/status may be transmitted, outputted and/or provided (via the handheld device(s) and/or the central station), in real-time, periodically (hourly, daily and/or weekly) and/or intermittently. Again, in one embodiment, the remote processing system(s) may generate data analytics using, based on and/or related to data of the (i) status and/or a state of one or more, or all of the patron tables of the restaurant, and/or (ii) change of status and/or state of one or more, or all of the patron tables of the restaurant. For example, the remote processing system may generate analytics, for a given restaurant, corresponding to:
a. state-to-state cycle time of one or more, or all, patron tables (e.g., average state-to-state cycle time—including, for example, on a periodic basis (e.g., daily, weekly, monthly and/or yearly)),
b. average turnaround time of one or more, or all, patron tables (ready state to ready state (i.e., which may be referred to as “table turnover time” or “table turnover optimization”),
c. average time of one or more, or all, patron tables are in a given state (e.g., ready state to ready state, occupied state and/or dirty state—including, for example, on a periodic basis (e.g., daily, weekly, monthly and/or yearly)),
d. average revenue per table relative to (i) state-to-state cycle time and/or (ii) average turnaround time—including, for example, on a periodic basis (e.g., daily, weekly, monthly and/or yearly), and
e. employee productivity (e.g., productivity of one or more, or all, table attendants—for example, on a periodic basis (e.g., daily, weekly, monthly and/or yearly).

Notably, in one embodiment, the remote processing system is a connection between the handheld device(s) and the central station wherein the handheld device(s) and the central station communicate directly with the remote processing system—and communicate indirectly with each other via the remote processing system. For example, with reference to FIG. 1D, in operation, the handheld device(s) may output, transmit and/or provide data which is representative of a status and/or a state of the patron table (and/or a change or an update of a status and/or a state of the patron table) associated with the unique identifier of the tag indicator (e.g., disposed in/on, secured or affixed to the particular patron table) to a remote processing system. Thereafter, the remote processing system may output, transmit and/or provide data which is representative of the status and/or the state of the patron table(s) to the central station. As noted above, in one embodiment, the central station generates display information based on the state/status (and/or changes therein) of each patron table of the restaurant using or based on information received from the handheld devices. The state/status of each patron table may be presented on the display of the central station (e.g., in floor map form or list form) and updated/changed in near real-time (as the patron table is serviced and/or observed by the table attendant, and read/detected by the handheld device). Information of the state/status of the patron tables individually, and the restaurant as a while, is available to an attendant at the central station (host/hostess station or desk) to, for example, improve the table management of restaurant, as well as the flow and/or experience of the patrons.

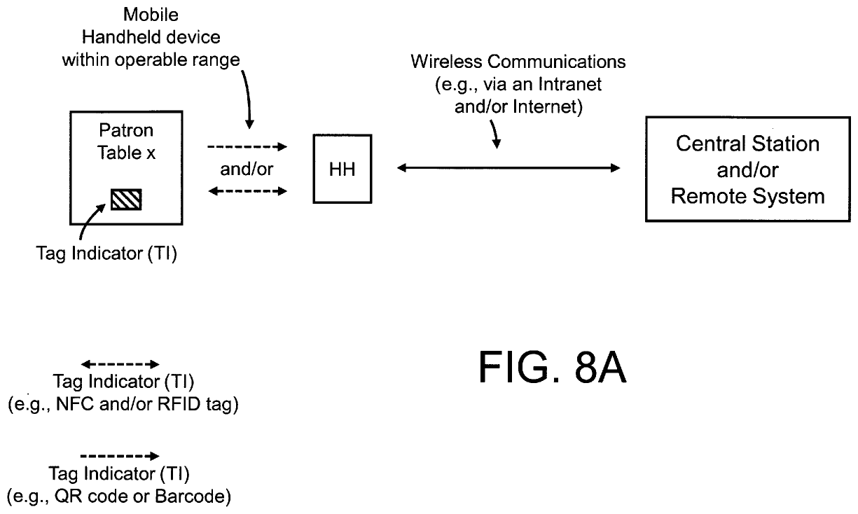

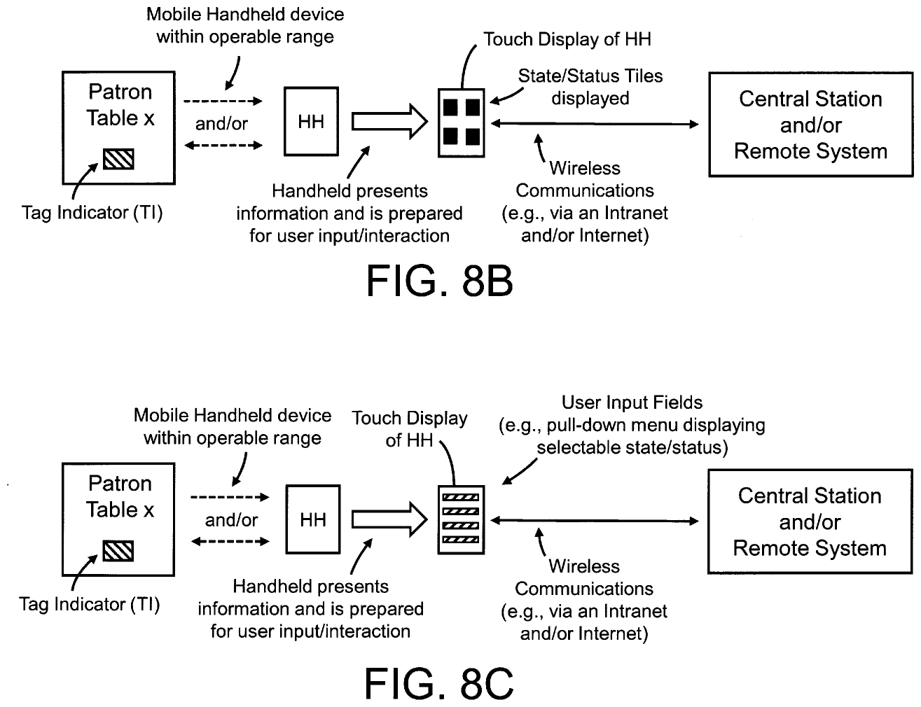

In one embodiment, the sequences of and change in states/statuses of a patron table may be table attendant determined, selected and/or input, via selection, input, and/or confirmation by the table attendant operating the handheld device. (See, e.g., FIGS. 8B and 8C). For example, a state/status of that patron table may be changed or updated to a different state/status based on an input from the table attendant (e.g., after cleaning, the table status is updated to cleaned/ready), for example, via a touch display (e.g., selection/tap of the “updated” state/status from a plurality of state/status tiles presented on the display on the handheld device (FIG. 8B) or a selection of the “updated” state from a pull-down menu presented on the display (see FIG. 8C). In this embodiment, the unique identifier information of the tag indicator (as read/detected by the tag reader) as well as a state/status of the associated patron table is output or transmitted to, for example, the central station and/or a remote processing system.

With reference to FIGS. 7A-7C, in another embodiment, the state/status (and/or change therein) of a patron table may be predetermined or predefined in accordance with a fixed table status sequence. For example, in one embodiment, a predetermined, fixed or predefined sequence of table states/statuses may include: (i) “ready” wherein a patron table is clean and ready to be occupied by patron(s)) to (ii) “seated” wherein patron(s) seated at a table (i.e., patron(s) occupy a particular table) to (iii) “dirty” wherein the patron table is dirty, for example, from the immediately previous patron(s), and then back to “ready” state/status (see, e.g., FIG. 7A). Here, in one embodiment, the tag reader of the handheld device optically, inductively and/or electronically detects and/or reads (wirelessly) the identification data of the tag indicator that uniquely identifies the patron table associated therewith, and communication circuitry of the handheld device outputs, transmits and/or provides such information to the central station and/or remote processing system. In response, the central station and/or remote processing system may change or “update” the state/status of that patron table to predefined/predetermined next state/status of the patron table based on (i) the predetermined/predefined sequence of the state/status and/or change in state/status of the patron table (see, e.g., FIGS. 7A-7C) and (ii) the current state/status of the patron table—which, in one embodiment, is known to, maintained and/or stored in the central station. In this embodiment, the table attendant, after the handheld device transmits, outputs or provides the data which is representative of the state/status and/or change in state/status of a patron table, need not select or enter a state/status of the patron table (or update thereto) that is associated with the tag indicator accessed by the handheld device. In one embodiment, however, the central station and/or remote processing system may request the table attendant “confirm” the state/status of the patron table (or update thereto)—as discussed above.

Notably, the system may employ one or more predetermined/predefined sequences of states, and a predetermined sequence of state may include any state, any number of states/statuses (i.e., two or more) in a sequence, and/or any order of states/status in the sequence(s)—all of which are intended to fall within the scope of the present inventions. For example, in one embodiment, the sequence of the state/status of the patron table (which again may be predetermined or predefined) may further include a state/status of “cleaning” (i.e., an attendant is in the process of cleaning the table to prepare the table to be occupied by patron(s)) (see, e.g., FIG. 7B). In another embodiment, the predetermined or predefined sequence of the states/statuses of the patron table may include two states including, for example, (i) “ready” wherein a patron table is clean and ready to be occupied by patron(s)) and (ii) “seated” wherein patron(s) seated at a table (i.e., patron(s) occupy a particular table) (see, e.g., FIG. 7C).

The predetermined/predefined sequences of table states may be one-time programmable wherein the sequence is fixed or more than one time programmable wherein the sequence may be redefined or re-programmed by, for example, a system operator. For example, the system may be programmed to a first predetermined/predefined sequences of table states (e.g., FIG. 7C) and subsequently reprogrammed to a second predetermined/predefined sequences of table states (e.g., FIG. 7A). In addition, the predetermined/predefined sequences of table states may be different for different patron tables of a restaurant. For example, the process for a first set of patron tables (one or more) may be determined via a first plurality of states of a first predetermined/predefined sequence (e.g., FIG. 7B), the process for a second set of patron tables (one or more) may be determined via a second plurality of states of a second predetermined/predefined sequence (e.g., FIG. 7A), and the process for a third set of patron tables (one or more) may be determined via a third plurality of states of a third predetermined/predefined sequence (e.g., FIG. 7C). Again, the restaurant management system may employ one or more predetermined/predefined sequences of states having any state, any order of states, any number of states/statuses (i.e., two or more) in a sequence, and/or any order of states/status in the sequence(s)—all of which are intended to fall within the scope of the present inventions.

With reference to FIG. 8A, in one embodiment, a handheld device is illustrated within operable range (e.g., via positioning the detector/reader of the handheld device in operable proximity (electronically, inductively, physically and/or optically)) of a tag indicator attached to a patron table. In operation, the table attendant accesses the unique identifier of the tag indicator of an associated table via the tag reader of the handheld device (e.g., via positioning the detector/reader of the handheld device in operable proximity (electronically, inductively, physically and/or optically) of the tag indicator (e.g., NFC, RFID, a QR code and/or bar code). (See, e.g., FIGS. 8A-8C). Once the unique information is read from the tag indicator (which correlates to the patron table associated with the tag indicator), the information is transmitted or provided (e.g., via an Intranet and/or the Internet) to a central station and/or remote processing system. In this embodiment, after the tag reader detects or reads the tag indicator, the table attendant need not to take further action with the handheld device (although in certain embodiments, the table attendant may take additional action (e.g., confirm the updated table state/status).

Thus, in one embodiment, upon accessing the tag indicator of an associated patron table via the tag reader of the handheld device, the handheld device communicates to the central station (via communication circuitry (e.g., wireless transmitter in/of the handheld device)), data which is representative of the patron table associated with the tag indicator (e.g., the unique information stored or programmed in and/or read from the particular tag indicator). In response, the central station changes the state/status of that patron table to an anticipated next state/status of the patron table based on the previous state/status of the patron table—which is known to, maintained and/or stored in the central station. For example, where a patron table is dirty, a table attendant, before accessing the tag indicator for that particular table, may service the patron table (cleaned and set). Thereafter, the table attendant may access the tag indicator of an associated table via the tag reader of the handheld device. In response, the handheld device transmits the information identifying the particular patron table and the central station, in response to such information, changes, updates and/or sets (e.g., automatically) the state/status of the associated patron table to a clean and ready to be occupied by patron(s)) state/status.

With reference to FIGS. 8B and 8C, in another embodiment, a handheld device is illustrated within operable range (e.g., via positioning the detector/reader of the handheld device in operable proximity (electronically, inductively, physically, optically)) of a tag indicator attached to a patron table. In operation, once the unique information is read from the tag indicator (which correlates to the patron table associated with the tag indicator), a state/status may be selected from a user interface, which may include one or more input mechanisms (for example, a touch screen overlay for a display (see FIG. 8B), button(s), knob(s), switch(es), microphone, and/or gesture recognition sensor(s), wherein the user may input data and/or commands) and/or one or more output mechanisms (for example, physical (e.g., haptic vibration device), audio (e.g., speaker/buzzer) and/or illumination (e.g., LED(s)). The data which is representative of the patron table (e.g., the unique information is read from the tag indicator) and the data which is representative of the state/status and/or change in state/status of that patron table is transmitted or provided (e.g., via an Intranet and/or the Internet) to a central station and/or remote processing system. Thereafter, the system may operate are discussed above (see, e.g., FIGS. 5A-5D).

Thus, in this embodiment, by accessing the tag indicator, the table attendant may select or input the state/status (and/or change in state/status) of a patron table after the tag reader (optically, inductively, physically and/or electronically) detects and/or reads the identification data of the tag indicator that uniquely identifies the patron table associated therewith. The communication circuitry of the handheld device may then output and transmit, to the central station, data which is representative of the patron table (e.g., the unique information is read from the tag indicator) and the data which is representative of the state/status and/or change in state/status of a patron table. The central station (e.g., a host/hostess station or desk) of the restaurant management system updates or changes the state/status of a patron table relative to the previous state/status.

Notably, the handheld device may display the possible states/statuses of the patron table (e.g., a plurality (or all) of those states/statuses discussed above) and await/request the table attendant to select or enter a new or change in current state/status of the patron table. (See, e.g., FIG. 8B). For example, in one embodiment, the handheld device may display a pull-down menu wherein the table attendant may select/input the appropriate state/status according to the state/status of the patron table associated with the tag indicator (e.g., “clean/ready” (i.e., the patron table is clean and ready to be occupied by patron(s)) after the table attendant has serviced (cleaned and set) the patron table). (See, FIG. 8C). For ease of operation and to facilitate uniformity of selection/input of the state/status of a patron table, the pull-down menu may present the table attendant with a limited number of options to select/input/confirm. Alternatively, however, the table attendant may also enter the status via a keypad.

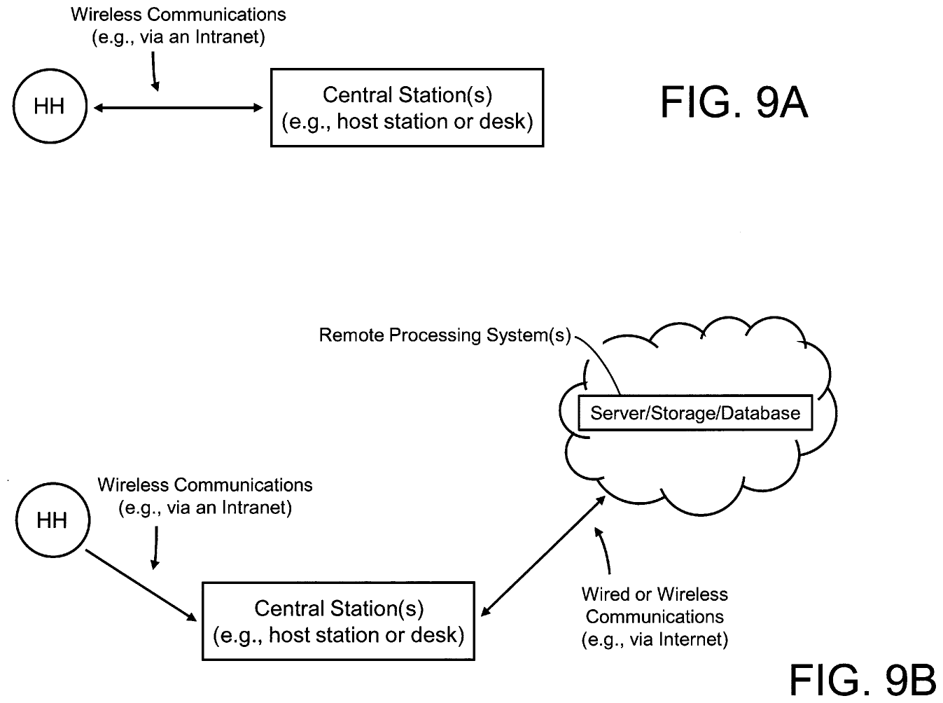

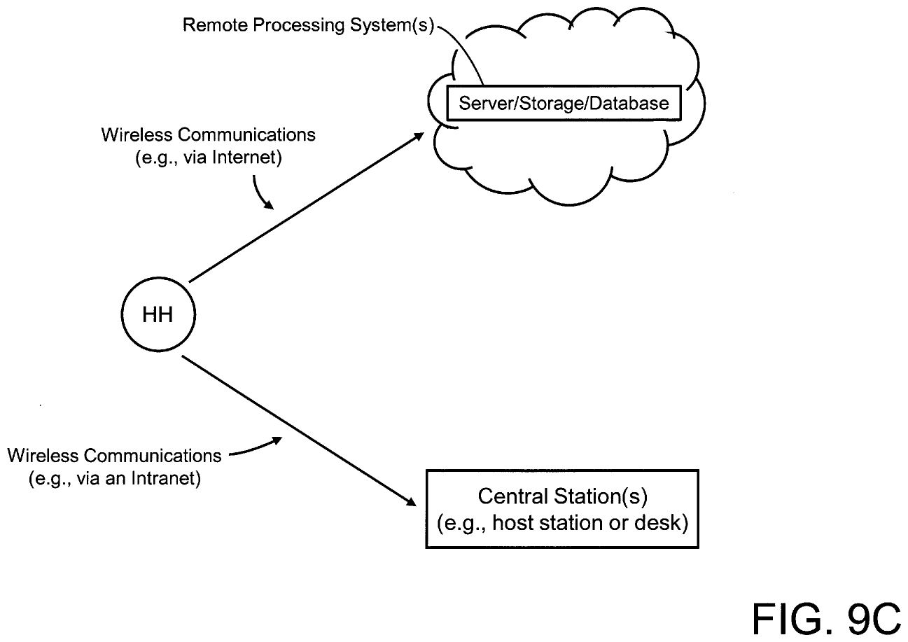

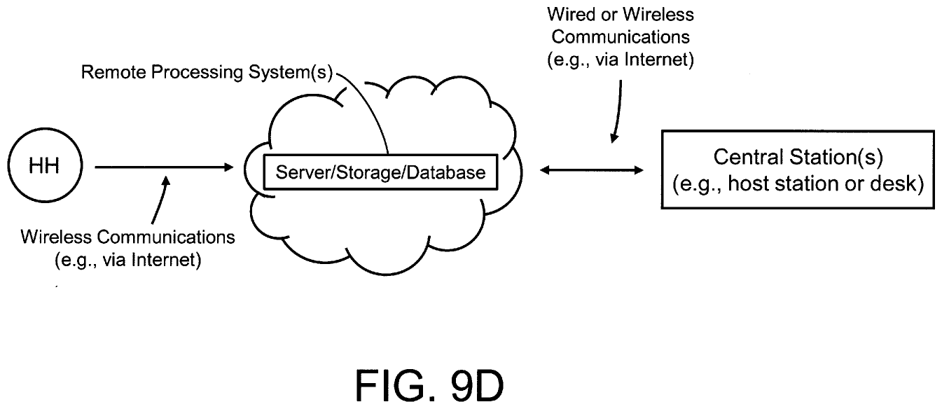

With reference to FIG. 9A, in one embodiment, the restaurant management systems including a patron table management system to, among other things, handheld device(s) to read or detect a tag indicator (e.g., an NFC tag, an RFID tag, a QR code, a barcode, etc.) having identification data, which is stored or programmed therein (e.g., one time or more than one time programmable) and to generate, transmit/output data which is representative of a status and/or a state of one or more, or all of the patron tables of the restaurant to a central station. For example, a handheld device is configured to send, in real-time or near real-time, table status changes or updates to the central station. This data may be logged in the central station and subsequently output to an attendant via the display of the central station. sent to the cloud service. Sending to the cloud may occur at one or more times and may be real-time or synced at an interval.

In another embodiment, with reference to FIG. 9B, the central station of the restaurant management system communicates, via the Internet, to a remote processing system (e.g., one or more servers in the “cloud”) to, for example, generate data analytics using, based on and/or related to data of the (i) status and/or a state of one or more, or all of the patron tables of the restaurant, and/or (ii) change of status and/or state of one or more, or all of the patron tables of the restaurant. This data may be logged in the central station and subsequently output to an attendant via the display of the central station. The transmission to the central station may be implemented be periodic (e.g., one or more times daily or weekly), at particular and/or random intervals, for example, based on certain events, and/or in real-time.

With reference to FIG. 9C, in another embodiment, one or more handheld device(s) communicate wirelessly (e.g. via an Intranet) to a central station to, for example, update the state/status of one or more patron table(s), as well as communicate wirelessly (e.g., via the Internet) to one or more remote systems (e.g., one or more servers in the “cloud”) to, for example, generate data analytics using, based on and/or related to data which is representative the (i) status and/or a state of one or more, or all of the patron tables of the restaurant, and/or (ii) change of status and/or state of one or more, or all of the patron tables of the restaurant. Notably, in one aspect, this embodiment implements a more distributed system architecture. The components of the system (handheld, central station and remote processing system) may be loosely coupled, and the event logs are sent to the cloud and table status updates are sent to the central station.

In yet another embodiment, with reference to FIG. 9D, one or more handheld device(s) communicate wirelessly (e.g. via Internet) with one or more remote systems (e.g., one or more servers in the “cloud”) and the remote system(s) are configured to provide (for example, in real-time) data which is representative of the (i) status and/or a state of one or more, or all of the patron tables of the restaurant, and/or (ii) change of status and/or state of one or more, or all of the patron tables of the restaurant to the central station. The table status updates are sent, via the mobile handheld device(s), to the remote processing system before being propagated to the central station. In this embodiment, it is advantageous to implement a real-time connection between the remote processing system and the central station to improve effectiveness.

Notably, the communication paths between the components of the system (handheld, central station and remote processing system) may be bidirectional and/or uni-directional.

As mentioned above, in one embodiment, the remote processing system (e.g., one or more servers in the “cloud”) may be employed to generate data analytics using, based on and/or related to data of the (i) status and/or a state of one or more, or all of the patron tables of the restaurant, and/or (ii) change of status and/or state of one or more, or all of the patron tables of the restaurant. The remote processing system may generate such analytics on, among other things, a table-by-table basis of the restaurant (including in relation to a patron table location or placement on the floor) and/or on the basis of the restaurant as a whole. For example, in one embodiment, the remote processing system may generate analytics, for a given restaurant, corresponding to:
a. state-to-state cycle time of one or more, or all, patron tables (e.g., average state-to-state cycle time—including, for example, on a periodic basis (e.g., daily, weekly, monthly and/or yearly)),
b. average turnaround time of one or more, or all, patron tables (ready state to ready state (i.e., which may be referred to as “table turnover time” or “table turnover optimization”),
c. average revenue per patron table correlated to average turnaround time of the patron table,
d. average time of one or more, or all, patron tables are in a given state (e.g., ready state to ready state, occupied state and/or dirty state—including, for example, on a periodic basis (e.g., daily, weekly, monthly and/or yearly)),
e. Average time spent by a party with occupancy
f. Correlate average time and occupancy to revenue
g. Correlate average time occupancy and table size/location (or table location in restaurant)
   i. Revenue
   ii. Cycle time
h. average revenue per table relative to (i) state-to-state cycle time and/or (ii) average turnaround time—including, for example, on a periodic basis (e.g., daily, weekly, monthly and/or yearly), and
i. employee productivity and performance (e.g., productivity of one or more, or all, table attendants—for example, on a periodic basis (e.g., daily, weekly, monthly and/or yearly).

Such data analytics may facilitate optimization of analytics to a point of essentially being real-time. Notably, the aforementioned data analytics of one, some and/or all of the patron table states, employee productivity, and/or the restaurant as a whole are merely exemplary and not intended to be limited thereto. Any/all data analytic(s) of one, some and/or all of the patron table states, and/or the restaurant as a whole, is/are intended to fall within the scope of the present inventions.

In one embodiment, each mobile handheld device is assigned to and associated with a particular table attendant. The table attendants may create credentials and all communications be signed with data unique to the table attendant. Moreover, certain handheld devices may be programmed with specific role-based states (e.g., “clean/ready” state) which may be assigned to certain table attendants to track overall productivity of each such table attendant. In this way, when the tag reader of such handheld device reads/detects the tag indicator of a particular table, and the communication circuitry transmits data which is representative of the identification data of that tag indicator, the central station and/or the remote processing system receives the data and automatically updates the associated table to the specific role-based states (i.e., “clean/ready” state).

In one embodiment, the restaurant management system may also include communications directed to “push notifications” wherein under certain conditions the system transmits notifications to one, some, all or a select group of employees or table attendants. For example, where a patron table state is set to “Dirty”, a push notification or alert communication may be transmitted to certain employees (e.g., to the handheld devices assigned to such employees)—including a notification that a particular table needs attention. Indeed, in one embodiment, the “push notifications” may be zoned wherein the notification is transmitted according to those table attendants that are responsible for the particular table that needs or tables that need attention.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the above embodiments of the inventions are merely exemplary. They are not intended to be exhaustive or to limit the inventions to the precise forms, techniques, materials and/or configurations disclosed. Many modifications and variations are possible in light of this disclosure. It is to be understood that other embodiments may be utilized and operational changes may be made without departing from the scope of the present inventions. As such, the scope of the inventions is not limited solely to the description above because the description of the above embodiments has been presented for the purposes of illustration and description.

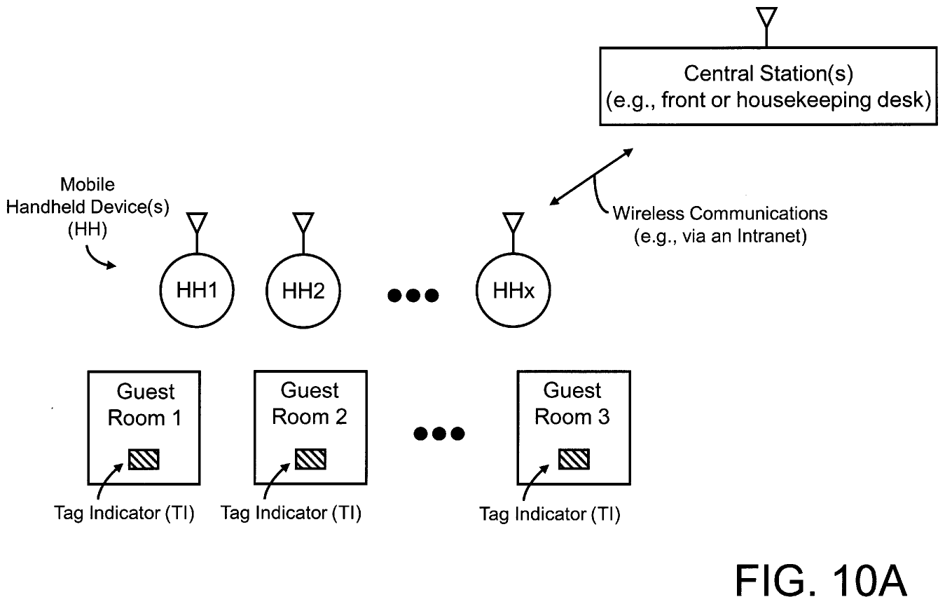

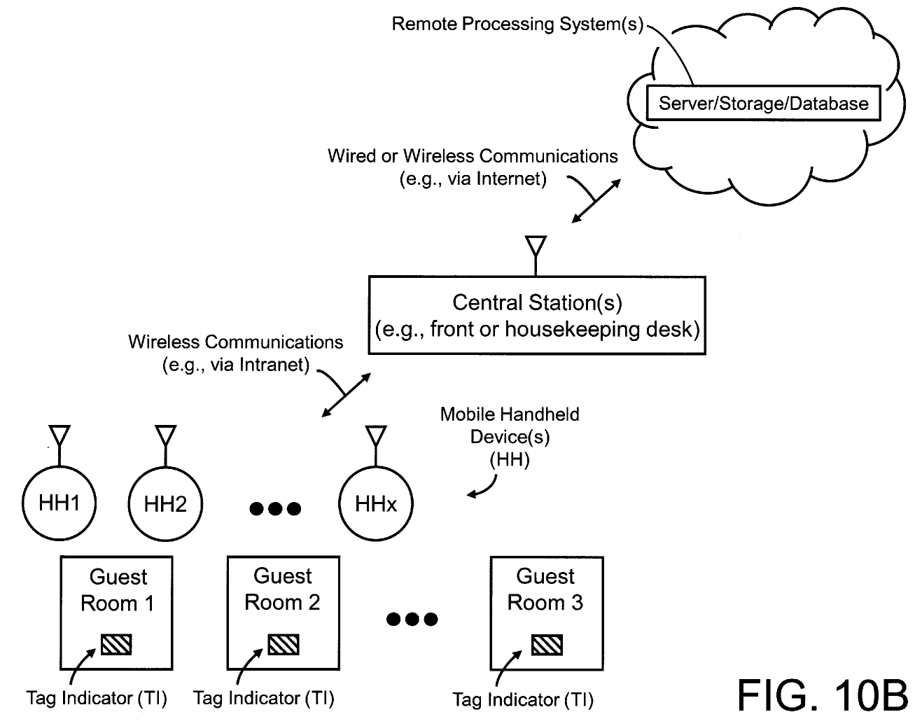

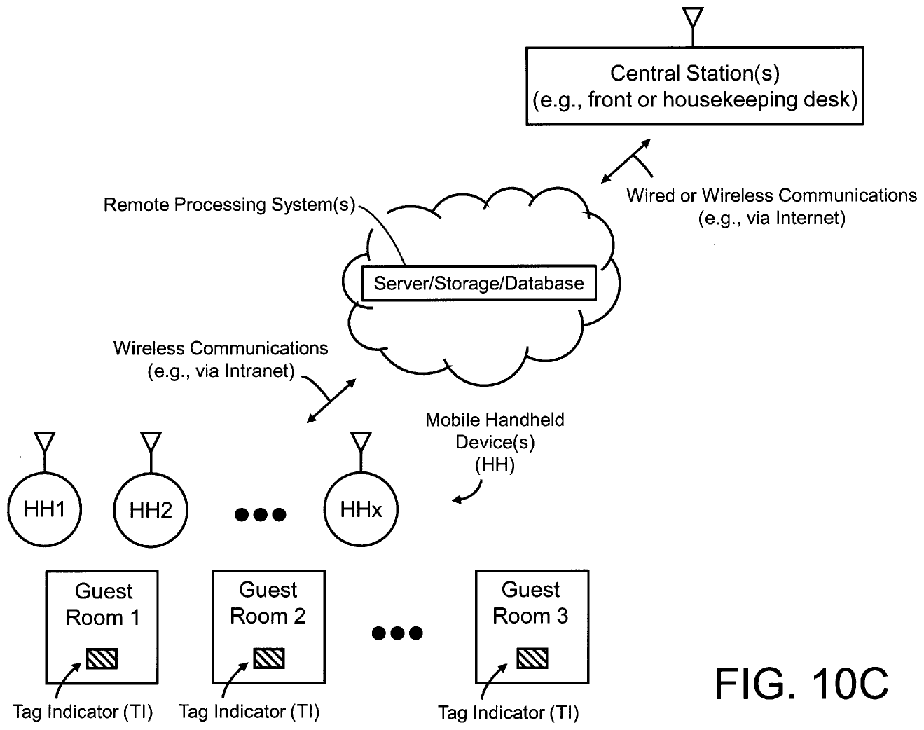

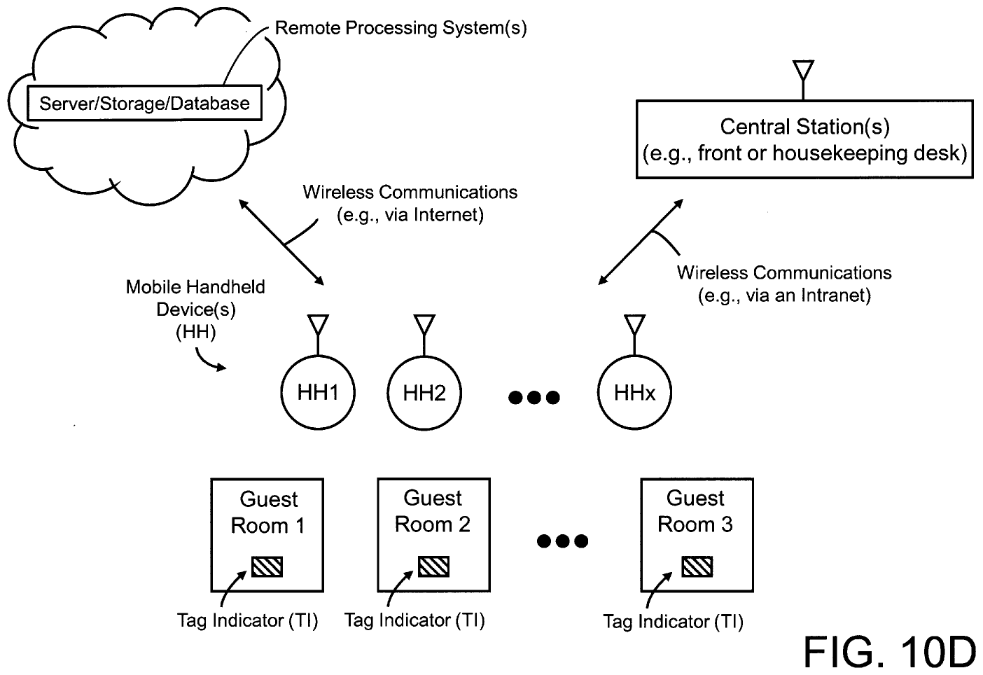

For example, although the present inventions have been largely/extensively described in the context of a restaurant management system including a patron table management system, the present inventions are applicable to other fields and/or industries (e.g., service industries) including, for example, hotel or commercial building management system including housekeeping/cleaning management system to, among other things, generate, transmit/output a status and/or a state of one or more, or all of the restrooms and public areas and, in the context of hotel(s), guest rooms. For example, with reference to FIGS. 10A-10D, in one embodiment, the housekeeping/cleaning management system includes one or more handheld devices to read or detect a tag indicator (e.g., an NFC tag, an RFID tag, a QR code, a barcode, etc.) associated with a guest room, wherein the tag indicator includes identification data, which is stored or programmed (e.g., one time or more than one time programmable) in the tag indicator, that uniquely identifies each tag indicator and, as such, the guest room associated therewith. The tag indicator may be located in and/or secured or fixed to or near a particular restroom and public area and/or guest room (in the context of a hotel (e.g., the tag indicator is secured to a wall in/of the room—e.g., to a wall located at or in an entrance of such room)). The operation of the housekeeping/cleaning management system may be like that described above in the context of a patron table management system wherein the mobile handheld devices communicate (via wirelessly, for example, via an Intranet) directly or through a proxy (such as a shared API, database, etc.) with, for example, a central station (e.g., a housekeeping desk and/or front desk) wherein the central station receives (e.g., via a Wi-Fi) information regarding the state/status of the guest room. The discussion above of the features, devices, systems, circuitry, processes, and operations of a restaurant management system including a patron table management system are entirely applicable to a hotel or commercial building management system including housekeeping/cleaning management system and, for the sake of brevity will not be repeated here. For example, once a room (e.g., customer restroom or guest room) or public area is cleaned/marked as dirty, the tag indicator may be scanned (NFC tag, RFID tag, etc.) and sent to the central station via wireless communication (Internet, Intranet, etc.). The system may thereafter notify appropriate employee(s) of rooms needing attention (e.g., cleaning services), as well as a visual (map, table, etc.) to allow employees to plan where to start or go next. As noted below, this may improve efficiency, along with gathering analytics on employee productivity and overall efficiency—managers will be able to see where improvement may be made.

As in connection with the restaurant management system, the remote processing system implemented in the hotel or commercial building management system (including housekeeping/cleaning management system) may generate data analytics using, based on and/or related to data of the (i) a status and/or a state of one or more, or all of the customer restrooms and public areas and/or guest rooms of a hotel, and/or (ii) change of status and/or state of one or more, or all of the restrooms and public areas and/or guest rooms (in the context of a hotel). Here, the remote processing system may generate analytics, for a given commercial building (e.g., hotel), corresponding to:
a. state-to-state cycle time of one or more, or all, guest rooms (e.g., average state-to-state cycle time—including, for example, on a periodic basis (e.g., daily, weekly, monthly and/or yearly)),
b. Time it takes to clean each room, each floor, entire hotel (e.g., on a periodic basis (e.g., daily, weekly, monthly and/or yearly))
c. average turnaround time of one or more, or all, guest rooms (check-out state to clean/ready state,
d. average time of one or more, or all, guest room are between clean/ready states (e.g., dirty room state to ready/clean state, and/or—including, for example, on a periodic basis (e.g., daily, weekly, monthly and/or yearly)),
e. cleaning staff productivity and crew efficiency (e.g., productivity of one or more, or all, cleaning staff—for example, on a periodic basis (e.g., daily, weekly, monthly and/or yearly)
f. monitor/locate cleaning staff (via logs)—what floor and room is being cleaned or was last cleaned.
   These analytics are also applicable to selected areas of other commercial buildings (e.g., customer restrooms and public areas of a commercial building) wherein the guest room correlates to customer restrooms and public areas of such other commercial building.

The remote processing system may generate such analytics on a room-by-room basis (e.g., customer restroom or guest room of the hotel) and/or on the basis of the commercial building or associated commercial buildings as a whole. Notably, the aforementioned data analytics of states of one, some and/or all of the restrooms and public areas and/or guest room (in the context of a hotel), employee productivity, and/or the commercial building (e.g., hotel) as a whole are merely exemplary and not intended to be limited thereto. Any/all data analytic(s) of one, some and/or all of the states of the restrooms and public areas and/or guest room (in the context of a hotel), and/or the commercial building (e.g., hotel) as a whole, is/are intended to fall within the scope of the present inventions.

Further, although not illustrated, the mobile handheld device and the central station may include memory to store programs/applications and data as well as circuitry (e.g., one or more processors, state machines or the like) to, among other things, manage the operation and interaction between the various components of the handheld device, implement programs/applications, as well as process/analyze data (e.g., in real-time) and implement instructions. In addition, although not illustrated, the mobile handheld device includes a power device, for example, a battery (e.g., a rechargeable battery), to provide electrical power to circuitry (e.g., the tag reader and communication circuitry) of the mobile handheld device.

Moreover, the components of the central station may be consolidated in one physical location or distributed to a plurality of different locations. For example, in one embodiment, the display and user interface employed by, for example, the host/hostess to oversee the table management of restaurant as well as manage the flow and/or experience of the patrons in the restaurant may be physically located separately from certain circuitry (e.g., processor and memory) of the central station that, for example, implement instructions and processes/analyzes data. In this regard, such circuitry may be located in a “computer room” whereas a display and user interface of the central station may be located at a host station or desk (i.e., close to or among the patron tables of the restaurant). Indeed, the central station may include a plurality of displays, processors and user interfaces located in one or a plurality of different physical locations. For the avoidance of doubt, these embodiments are also entirely applicable to a hotel or commercial building management system including housekeeping/cleaning management system.

Similarly, the communication circuitry of the central station may be consolidated in a physical location or distributed to a plurality of different locations near various components of the central station. For example, in one embodiment, where certain processing circuitry (and memory) are located in a “computer room” and a display and user interface of the central station is located at a host station or desk, a portion of the communication circuitry (e.g., which interfaces directly with the mobile handheld devices) may be located with and connected to the processing circuitry and additional communication circuitry may be employed to connect the processing circuitry in the “computer room” to a display—user interface which is located at a host station or desk. Again, for the avoidance of doubt, these embodiments are also entirely applicable to a hotel or commercial building management system including housekeeping/cleaning management system.

In addition, in one embodiment, the mobile handheld device may include processing circuitry and memory. For example, the handheld device may store the current state/status of the patron table in memory and, in response to accessing the unique identifier of the tag indicator of an associated table via the detector/reader of the handheld device, the handheld device may display the previously known state/status of the patron table and await/request the table attendant to confirm the anticipated next or new current state/status of the patron table (e.g., via a confirmation input “button” on a display (e.g., touch-screen type) and/or a keypad). In this embodiment, the anticipated next state/status of the patron table (and anticipated change in state/status thereof) is based on the previous state/status of the patron table. For example, where the previous state/status of the patron table was table occupied or patron(s) seated (i.e., patron(s) occupy the table), when the table attendant accesses the unique identifier of the tag indicator of an associated table via the handheld device, the next state/status of the patron table may be table dirty (the table is dirty, for example, from the immediately previous patron(s)) and/or cleaning in process (i.e., an attendant is in the process of cleaning the table to prepare the table to be occupied by patron(s)). After the table attendant has serviced (cleaned and set) the patron table and the table attendant may again access the tag indicator of an associated table via mobile handheld device wherein the state/status of the patron table may be automatically, or in response to confirmation input (from the table attendant), updated to the state/status of the patron table to clean and ready to be occupied by patron(s) (i.e., after the table attendant has serviced (cleaned and set) the patron table). Again, for the avoidance of doubt, these embodiments are also entirely applicable to a hotel or commercial building management system including housekeeping/cleaning management system.

Further, in another embodiment, in lieu of storing or maintaining the current state/status of the patron table(s) in the mobile handheld device, or in addition thereto, upon accessing the tag indicator of an associated table via the detector/reader of the handheld device, the handheld device may receive, retrieve, request and/or download the state/status of the patron table (based on the unique identifier of the tag indicator affixed to the associated table as detected/read by the detector/reader of the handheld device) from, for example, the central station (via communication circuitry (e.g., wireless transmitter/receiver in/of the handheld device)), as stored or maintained in memory therein. Thereafter, a change in the state/status may be implemented using any of the techniques or processes described herein. For example, after the table attendant has serviced the patron table (cleaned and set), the table attendant may again access the tag indicator of an associated table via the detector/reader of the mobile handheld device wherein the state/status of the patron table may be automatically, or in response to confirmation input (from the table attendant on, for example, a touch screen), updated to a clean and ready to be occupied by patron(s)) state/status which may be output or transmitted to the central station (via a wireless transmitter of the mobile handheld device). Again, for the avoidance of doubt, these embodiments are also entirely applicable to a hotel or commercial building management system including housekeeping/cleaning management system.

Notably, the term “circuitry”, means, among other things, a circuit (whether integrated or otherwise), a group of such circuits, one or more processors, one or more state machines, one or more processors implementing software, one or more gate arrays, programmable gate arrays and/or field programmable gate arrays, or a combination of one or more circuits (whether integrated or otherwise), one or more state machines, one or more processors, one or more processors implementing software, one or more gate arrays, programmable gate arrays and/or field programmable gate arrays.

Importantly, the present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof.

Notably, reference herein to “one embodiment” or “an embodiment” (or the like) means that a particular feature, structure, or characteristic described in connection with the embodiment may be included, employed and/or incorporated in one, some or all of the embodiments of the present inventions. The usages or appearances of the phrase “in one embodiment” or “in another embodiment” (or the like) in the specification are not referring to the same embodiment, nor are separate or alternative embodiments necessarily mutually exclusive of one or more other embodiments, nor limited to a single exclusive embodiment. The same applies to the term “implementation.” The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

Further, an embodiment or implementation described herein as “exemplary” is not to be construed as ideal, preferred or advantageous, for example, over other embodiments or implementations; rather, it is intended convey or indicate the embodiment or embodiments are example embodiment(s).

Although the present inventions have been described in certain specific aspects, many additional modifications and variations would be apparent to those skilled in the art. It is therefore to be understood that the present inventions may be practiced otherwise than specifically described without departing from the scope and spirit of the present inventions. Thus, embodiments of the present inventions should be considered in all respects as illustrative/exemplary and not restrictive.

The terms “comprises,” “comprising,” “includes,” “including,” “have,” and “having” or any other variation thereof, are intended to cover a non-exclusive inclusion, such that a process, method, circuit, system, article, or apparatus that comprises a list of parts or elements does not include only those parts or elements but may include other parts or elements not expressly listed or inherent to such process, method, article, or apparatus. Further, use of the terms “connect”, “connected”, “connecting” or “connection” herein should be broadly interpreted to include direct or indirect (e.g., via one or more conductors and/or intermediate devices/elements (active or passive) and/or via inductive or capacitive coupling)) unless intended otherwise (e.g., use of the terms “directly connect” or “directly connected”).

The terms “a” and “an” herein do not denote a limitation of quantity, but rather denote the presence of at least one of the referenced item. Further, the terms “first,” “second,” and the like, herein do not denote any order, quantity, or importance, but rather are used to distinguish one element/circuit/feature from another.

In the claims, the term “NFC tag” means or includes “NFC tag” and/or “RFID tag”; for the avoidance of doubt, the same is true of the plural forms thereof. In addition, in the claims, the term “status” (e.g., status of a patron table) means or includes “status” and/or “state” (e.g., state of a patron table); for the avoidance of doubt, the same is true of the plural forms thereof.

Again, there are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations.

What is claimed is:

1. A patron table management system for a restaurant including a plurality of patron tables, the patron table management system comprising:
a plurality of tag indicators, each tag indicator includes an NFC tag, secured to and associated with a particular patron table, wherein each tag indicator includes unique identification data which is stored or programmed in the NFC tag;
at least one mobile handheld device including:
a tag reader to read the unique identification data stored or programmed in a NFC tag of a tag indicator when in operable proximity to the NFC tag of the 8 tag indicator, and
wireless communication circuitry, coupled to the tag reader, configured to wirelessly transmit (i) unique identification data stored or programmed in the NFC tag of a tag indicator and (ii) a status of the patron table associated therewith, wherein the status of a patron table includes a first status which is representative of a table clean or table ready; and
a central station, remote from the plurality of tag indicators that are secured to patron tables, configured to output information of a status of each patron table of the plurality of patron tables of the restaurant, the central station including:
communication circuitry, configured to wirelessly receive, from the least one mobile handheld device, the unique identification data of a tag indicator and a status of the patron table associated therewith, and
a display, coupled to the communication circuitry of the central station, to output information of a status of each patron table of the plurality of patron tables of the restaurant.

2. The patron table management system of claim 1 wherein the at least one mobile handheld device further includes:
a user interface, coupled to the tag reader and the wireless communication circuitry, to display a plurality of statuses of a patron table associated with and in response to the unique identification data of the NFC tag of the tag indicator read by the tag reader.

3. The patron table management system of claim 1 wherein the at least one mobile handheld device further includes:
a user interface, coupled to the tag reader and the wireless communication circuitry, the user interface including:
a touch-screen to display a plurality of statuses of a patron table associated with and in response to the unique identification data of the NFC tag of the tag indicator read by the tag reader, and to receive a user input of a selected status of the patron table in response thereto, and
wherein the wireless communication circuitry of the at least one mobile handheld device is configured to wirelessly transmit (i) unique identification data stored or programmed in the NFC tag of a tag indicator and (ii) the selected status of the patron table of the patron table associated with the NFC tag of a tag indicator.

4. The patron table management system of claim 1 wherein:
the wireless communication circuitry of the at least one mobile handheld device configured to wirelessly transmit (i) unique identification data stored or programmed in the NFC tag of a tag indicator and (ii) a status of the patron table associated therewith via an intranet.

5. The patron table management system of claim 1 wherein the at least one mobile handheld device further includes:
a user interface, coupled to the wireless communication circuitry, the user interface having a haptic vibration device to vibrate in response to the wireless transmission of the (i) unique identification data stored or programmed in the NFC tag of a tag indicator and (ii) a status of the patron table associated therewith via the wireless communication circuitry.

6. The patron table management system of claim 1 wherein:
a status of the patron table associated with the unique identification data stored or programmed in the NFC tag of a tag indicator that is read by the tag reader of the at least one mobile handheld device is determined by the central station based on (i) an immediately previous status of the patron table stored in the central station and (ii) a preprogrammed or fixed sequence of table statuses.

7. The patron table management system of claim 6 wherein:
the central station, in response to determining a current status of the patron table associated the unique identification data stored or programmed in the NFC tag of a tag indicator that is read by the tag reader of the at least one mobile handheld device and transmitted by the wireless communication circuitry, transmits a request to the at least one mobile handheld device to verify the current table status.

8. The patron table management system of claim 1 wherein:
the display outputs the information of the status of each patron table of the plurality of patron tables of the restaurant in a map or floor layout.

9. The patron table management system of claim 1 wherein:
the communication circuitry of the central station transmits, via the Internet, data corresponding to the status and/or change in status of the plurality of patron tables to a remote processing system.

10. The patron table management system of claim 9 wherein:
the remote processing system, using the (i) status of the patron tables of the restaurant and/or (ii) change of status of the patron tables of the restaurant, generates analytics corresponding to at least one of:
a. a status-to-status cycle time of patron tables of the restaurant,
b. an average turnaround time of the patron tables of the restaurant,
c. an average time the patron tables of the restaurant are in a given status,
d. average revenue per table of the restaurant relative to (i) status-to-status cycle time and/or (ii) average turnaround time, and
e. employee productivity.

11. A patron table management system for a restaurant including a plurality of patron tables, the patron table management system comprising:
a plurality of tag indicators, each tag indicator includes an NFC tag, secured to and associated with a particular patron table, wherein each tag indicator includes unique identification data which is stored or programmed in the NFC tag;
at least one mobile handheld device including:
a tag reader to read the unique identification data stored or programmed in a NFC tag of a tag indicator when in operable proximity to the NFC tag of the 8 tag indicator, and
wireless communication circuitry, coupled to the tag reader, configured to wirelessly transmit (i) unique identification data stored or programmed in the NFC tag of a tag indicator and (ii) a status of the patron table associated therewith,
wherein the status of a patron table includes (a) a first status which is representative of a table clean or table ready and (b) a second status which is representative of a table occupied; and
a central station, remote from the plurality of tag indicators that are secured to patron tables, configured to store and output information of a current status of each patron table of the plurality of patron tables of the restaurant, the central station 18 including:
communication circuitry, configured to wirelessly receive, from the least one mobile handheld device, the unique identification data of a tag indicator and a current status of the patron table associated therewith, and
a display, coupled to the communication circuitry of the central station, to visually output information of a current status of each patron table of the plurality 24 of patron tables of the restaurant including the first status or second status.

12. The patron table management system of claim 11 wherein:
wherein the status of a patron table further includes (a) a third status which is representative of a cleaning table and (b) a fourth status of a table dirty.

13. The patron table management system of claim 11 wherein the at least one mobile handheld device further includes:
a user interface, coupled to the tag reader and the wireless communication circuitry, the user interface including:
a touch-screen to display a plurality of statuses of a patron table associated with and in response to the unique identification data of the NFC tag of the tag indicator read by the tag reader, and to receive a user input of a selected status of the patron table in response thereto, and
wherein the wireless communication circuitry of the at least one mobile handheld device is configured to wirelessly transmit (i) unique identification data stored or programmed in the NFC tag of a tag indicator and (ii) the selected status of the patron table of the patron table associated with the NFC tag of a tag indicator.

14. The patron table management system of claim 11 wherein the at least one mobile handheld device further includes:
a user interface, coupled to the wireless communication circuitry, the user interface having a haptic vibration device to vibrate in response to the wireless transmission of the (i) unique identification data stored or programmed in the NFC tag of a tag indicator and (ii) a status of the patron table associated therewith via the wireless communication circuitry.

15. The patron table management system of claim 11 wherein:
a status of the patron table associated with the unique identification data stored or programmed in the NFC tag of a tag indicator that is read by the tag reader of the at least one mobile handheld device is determined by the central station based on (i) an immediately previous status of the patron table stored in the central station and (ii) a preprogrammed or fixed sequence of table statuses.

16. The patron table management system of claim 15 wherein:
the central station, in response to determining a current status of the patron table associated the unique identification data stored or programmed in the NFC tag of a tag indicator that is read by the tag reader of the at least one mobile handheld device and transmitted by the wireless communication circuitry, transmits a request to the at least one mobile handheld device to verify the current table status.

17. The patron table management system of claim 11 wherein:
the display outputs the information of the status of each patron table of the plurality of patron tables of the restaurant in a map or floor layout.

18. The patron table management system of claim 11 wherein:
the communication circuitry of the central station transmits, via the Internet, data corresponding to the status and/or change in status of the plurality of patron tables to a remote processing system.

19. The patron table management system of claim 18 wherein:
the remote processing system, using the (i) status of the patron tables of the restaurant and/or (ii) change of status of the patron tables of the restaurant, generates analytics corresponding to at least one of:
a. a status-to-status cycle time of patron tables of the restaurant,
b. an average turnaround time of the patron tables of the restaurant,
c. an average time the patron tables of the restaurant are in a given status,
d. average revenue per table of the restaurant relative to (i) status-to-status cycle time and/or (ii) average turnaround time, and
e. employee productivity.

20. A patron table management system for a restaurant including a plurality of patron tables, the patron table management system comprising:
a plurality of tag indicators, each tag indicator includes an NFC tag, secured to and associated with a particular patron table, wherein each tag indicator includes unique identification data which is stored or programmed in the NFC tag;
at least one mobile handheld device including:
a tag reader to read the unique identification data stored or programmed in a NFC tag of a tag indicator when in operable proximity to the NFC tag of the 8 tag indicator, and
wireless communication circuitry, coupled to the tag reader, configured to wirelessly transmit (i) unique identification data stored or programmed in the NFC tag of a tag indicator and (ii) a status of the patron table associated therewith, wherein the status of a patron table includes (a) a first status which is representative of a table clean or table ready, (b) a second status which is representative of a table occupied, and (c) a third status which is representative of a table dirty; and
a central station, remote from the plurality of tag indicators that are secured to patron tables, configured to store and output information of a current status of each patron table of the plurality of patron tables of the restaurant, the central station including:
communication circuitry, configured to wirelessly receive, from the least one mobile handheld device, the unique identification data of a tag indicator and a current status of the patron table associated therewith, and
a display, coupled to the communication circuitry of the central station, to visually output information of a current status of each patron table of the plurality of patron tables of the restaurant including a first status, second status and a third status.
